(19) United States
(12) Patent Application Publication
(10) Pub. No.: US 2009/0281891 A1
(43) Pub. Date: Nov. 12, 2009

(54) SYSTEMS AND METHODS FOR VENDING MACHINE FINANCING

(76) Inventors: Jay S. Walker, Ridgefield, CT (US); Daniel E. Tedesco, Huntington, CT (US); Paul T. Breitenbach, Wilton, CT (US); Paul D. Signorelli, Ridgefield, CT (US); Sih Y. Lee, Northvale, NJ (US)

Correspondence Address: WALKER DIGITAL MANAGEMENT, LLC, 2 HIGH RIDGE PARK, STAMFORD, CT, 06905, US

(21) Appl. No.: 11/813,596

(22) PCT Filed: Sep. 6, 2006
(86) PCT No.: PCT/US06/34647

§ 371 Date: Jul. 10, 2007

(51) Int. Cl. G06Q 40/00; G06Q 10/00; G06Q 20/00; G06Q 30/00; G06Q 50/00

(52) U.S. Cl. 705/14.38; 705/400; 705/38; 705/30

(57) ABSTRACT

According to some embodiments, systems, methods, and/or articles of manufacture are associated with facilitating and/or managing vending machine financing and/or other vending machine agreements.

### BACKGROUND

Traditional vending machines provide sellers with the ability to offer products to consumers in an automated fashion, thereby allowing the sale of products at places where face-to-face retailing efforts are not practical (e.g., the lobby of an office building) and at times inconvenient for traditional retailers (e.g., 3:00 AM on a Tuesday morning). The most modern versions of such vending machines are capable of implementing various degrees of logic and management features that are directed to increasing revenues and/or profits in stand-alone or networked environments. These machines may, for example, be equipped with various hardware and/or software capabilities that are desirable by vending route operators/owners. These machines are also, however, typically much more expensive than standard vending machines.

Accordingly, many vending route operators/owners may not have sufficient funds or means with which to purchase such machines. The operators may therefore choose to purchase cheaper vending machines that lack such desirable features and/or choose to finance and/or lease one or more advanced vending machines. Standard financing arrangements that may be available to such operators may, however, be insufficient, inappropriate, and/or inefficient for the financing of vending machines.

### BRIEF DESCRIPTION OF THE FIGURES

An understanding of embodiments described herein and many of the attendant advantages thereof may be readily obtained by reference to the following detailed description when considered with the accompanying figures, wherein:

FIG. 1 is a block diagram of a system according to some embodiments;

FIG. 2 is a block diagram of a system according to some embodiments;

FIG. 3 is a flow diagram of a method according to some embodiments;

FIG. 4 is a flow diagram of a method according to some embodiments;

FIG. 5 is a flow diagram of a method according to some embodiments;

FIG. 6 is a flow diagram of a method according to some embodiments;

FIG. 7 is a data table diagram illustrating an example data structure according to some embodiments;

FIG. 8 is a data table diagram illustrating an example data structure according to some embodiments;

FIG. 9 is a data table diagram illustrating an example data structure according to some embodiments;

FIG. 10 is a data table diagram illustrating an example data structure according to some embodiments;

FIG. 11 is a data table diagram illustrating an example data structure according to some embodiments;

FIG. 12 is a block diagram of a system according to some embodiments;

FIG. 13 is a block diagram illustrating an example of the external appearance of a vending machine according to some embodiments;

FIG. 14 is a block diagram of a system according to some embodiments;

FIG. 15A and FIG. 15B are schematic block diagrams of exemplary configurations of a software architecture according to some embodiments; and

FIG. 16 is a block diagram of a system according to some embodiments.

### DETAILED DESCRIPTION

### I. Introduction

Vending machine operators typically experience great difficulty in trying to grow their vending businesses. It can often be quite difficult, for example, for vending route operators/owners to grow sales at a given vending machine location and/or to acquire new locations (e.g., expansion). Applicants have recognized that such operators may greatly benefit by being able to leverage advanced features that may be available in some modern vending machines. Such operators could, for example, lease, rent, or purchase (e.g., via credit and/or financing) one or more advanced vending machines that may facilitate the increase of revenues, profits, volume, etc. The operators may also or alternatively benefit from a relationship with the supplier, manufacturer, franchisee, and/or other entity associated with the financed vending machine. Operators may not only benefit from implementation of advanced and potentially proprietary features of the vending machines, for example, but they may also benefit from good will, national advertising, national purchasing power, and/or other qualities associated with the provider and/or financer of the vending machine.

Applicants have recognized that, in some situations, it may be advantageous to provide systems, methods, and articles of manufacture to facilitate and/or conduct or manage vending machine financing. Some embodiments, for example, are directed to providing (e.g., in exchange for a fee) a vending machine to an operator. In some embodiments, a fee may be scheduled to be paid by the operator on a periodic basis. Embodiments may further comprise processing one or more electronic payment transactions associated with customers of the vending machine, determining a history of payment of the fee by the operator (and/or another performance history associated with the operator), determining, based at least in part on the history of payment of the fee (and/or other performance history) by the operator, a settlement amount, and/or settling with the operator for the settlement amount, wherein the settlement amount is based on an amount owed to the operator in association with the one or more processed electronic payment transactions associated with customers of the vending machine.

Some embodiments may be generally directed to financing arrangements associated with a plurality of vending machines. Applicants have recognized, for example, that vending machine performance may be utilized, such as with respect to a plurality of vending machines, to facilitate, effectuate, and/or otherwise affect financing arrangements. Embodiments may therefore comprise, for example, providing, in exchange for a first fee, a first vending machine to an operator, wherein the first fee is a function of first sales data associated with the first vending machine and providing, in exchange for a second fee, a second vending machine to the operator, wherein the second fee is a function of second sales data associated with the second vending machine. Embodiments may further comprise determining, based on the function of the first sales data, that the first vending machine comprises, has processed, and/or has received insufficient funds to support payment of the first fee, a difference between the first fee and the funds of the first vending machine defining a deficiency amount, and/or determining, based on the function of the second sales data, that the second vending machine comprises funds in excess of the second fee, a difference between the second fee and the funds of the second vending machine defining an excess amount; and collecting (i) the deficiency amount, (ii) the second fee, and (iii) at least a portion of the excess amount from the second vending machine, wherein the addition of the deficiency amount and the collected portion of the excess amount from the second vending machine is less than or equal to the first fee.

Applicants have yet further recognized that, in some situations, poor operator and/or vending machine performance may be at least partially remedied by controlling and/or limiting features associated with a vending machine. Some embodiments comprise, for example, providing, in exchange for a fee, a vending machine to an operator, wherein the fee is scheduled to be paid by the operator on a payment date, determining that the operator's payment of the fee is delinquent and/or that the operator has failed to meet an obligation, and transmitting, after the determination that the operator's payment of the fee is delinquent and/or that the operator has failed to perform the obligation, one or more signals to prevent the operator from accessing a cash bin of the vending machine. Other features of the vending machine (e.g., in addition to or instead of the cash bin) may also or alternatively be disabled and/or engaged. In some embodiments, altering the functionality of the vending machine based on operator and/or vending machine performance (or lack thereof may generally be referred to herein as a “corrective action”.

Applicants have also recognized that, in some situations, rewarding operators for good financing and/or other contractual performance may be advantageous. In some embodiments, such rewards may be associated with features of the vending machine. Some embodiments may comprise, for example, providing, in exchange for a fee, a vending machine to an operator, wherein the fee is scheduled to be paid by the operator on a periodic basis, determining a history of payment of the fee by the operator, determining, based at least in part on the history of payment of the fee by the operator, a promotion activation code, and/or providing the promotion activation code to the operator, wherein the promotion activation code is operable to be accepted by the vending machine to activate one or more promotion capabilities of the vending machine.

### II. Terms and Definitions

Throughout the description that follows and unless otherwise specified, the following terms may include and/or encompass the example meanings provided in this section. These terms and illustrative example meanings are provided to clarify the language selected to describe embodiments both in the specification and in the appended claims.

Some embodiments described herein are associated with a “control system”. As used herein, the term “control system” may generally refer to any combination of hardware, software, firmware, and/or microcode that is operative to carry out and/or facilitate embodiments described herein. For example, a control system may comprise a processor performing instructions of a program to facilitate and/or manage vending machine financing. The control system may also or alternatively be configured to incorporate logic and/or rules to control features of a vending machine pursuant to various financing arrangement events, conditions, and/or situations. The control system may comprise, according to some embodiments, a single device and/or component or may comprise any practicable number of networked devices. In some embodiments, a control system may comprise a controller in communication with one or more vending machines.

As used herein, the term “controller” may generally refer to any device that may communicate with one or more vending machines, one or more third-party servers, one or more remote controllers, one or more customer devices, one or more peripheral devices and/or other network devices, and may be capable of relaying communications to and/or from such devices. A controller or server may, for example, comprise one or more network devices and/or components.

Some embodiments described herein are associated with a “network device”. As used herein, the term “network device” may generally refer to any device that can communicate via a network. Examples of network devices include a Personal Computer (PC), a workstation, a server, a printer, a scanner, a facsimile machine, a copier, a Personal Digital Assistant (PDA), a storage device (e.g., a disk drive), a hub, a router, a switch, and a modem or a wireless phone. In some embodiments, network devices may comprise one or more network components, such as a Static Random Access Memory (SRAM) device or module, a network processor, and/or a network communication path, connection, port, or cable. Some examples of network devices may include, but are not limited to, servers or controllers, customer devises, vending machines, input devices, output devices, and peripheral devices.

As used herein, the terms “customer device” and “user device” may be used interchangeably and may generally refer to any device owned and/or operated by, or otherwise associated with a customer, which device is capable of accessing and/or outputting online and/or offline content. Customer devices may communicate with one or more servers or controllers, one or more vending machines, one or more third-party service provider servers, one or more user terminals, and/or other network devices. In some embodiments, customer devices may, for example, include gaming devices, PC devices, PDA devices, Point-Of-Sale (POS) terminals, point of display terminals, kiosks, telephones, cellular phones, portable media players (e.g., an Apple® iPod®), Automated Teller Machines (ATM) devices, pagers, and/or combinations of such devices.

As used herein, the term “vending machine” may generally refer to any system, apparatus, and/or module that is operable to provide and/or facilitate the provision of goods and/or services to customers. Vending machines may include, but are not limited to, for example, one or more stand-alone, networked, automated, mechanical, and/or electrical devices coupled to dispense products such as beverages and/or snacks to customers. In some embodiments, vending machines may comprise, be coupled to, and/or may be otherwise associated with one or more input devices, output devices, and/or peripheral devices (e.g., to operate in accordance with embodiments described herein).

As used herein, the term “input device” may generally refer to a device that is used to receive input. An input device may communicate with and/or be part of another device (e.g. a point of sale terminal, a point of display terminal, a customer terminal, a server, a customer device, a vending machine, a controller, and/or a peripheral device). Some examples of input devices include, but are not limited to: a bar-code scanner, a magnetic stripe reader, a computer keyboard, a point-of-sale terminal keypad, a touch-screen, a microphone, an infrared sensor, a sonic ranger, a computer port, a video camera, a motion detector, a digital camera, a network card, a Universal Serial Bus (USE) port, a Global Positioning System (GPS) receiver, a Radio Frequency IDentification (RFID) receiver, a RF receiver, a thermometer, a pressure sensor, and a weight scale or mass balance.

As used herein, the term “output device” may generally refer to a device that is used to output information. An output device may communicate with and/or be part of another device (e.g. a vending machine, a point of sale terminal, a point of display terminal, a customer device, and/or a controller). Possible output devices may include, but are not limited to: a Cathode Ray Tube (CRT) monitor, a Liquid Crystal Display (LCD) screen, a Light Emitting Diode (LED) screen, a printer, an audio speaker, an Infra-red Radiation (IR) transmitter, an RF transmitter, and/or a product hopper, dispenser, and/or data port.

As used herein, the terms “product,” “good,” “item”, “merchandise,” and “service” may be used interchangeably and may generally refer to anything licensed, leased, sold, available for sale, available for lease, available for licensing, and/or offered or presented for sale, lease, or licensing including individual products, packages of products (such as mystery packages), subscriptions to products, contracts, information, services, and intangibles. Examples of goods sold at vending machines may include, but are not limited to: beverages (e.g., cans or bottles of soda or water), snacks (e.g., candy bars), and recordable media (e.g., pre-recorded and/or dynamically-recorded disks or tapes). Examples of services sold by vending machines include car washes, photography services and access to digital content (e.g., permitting the downloading of digital picture, video, and/or audio files such as audio “ring tones” and/or wallpapers to a handheld device).

Some embodiments described herein are associated with an “operator”. As used herein, the term “operator” may generally refer to the owner and/or operator of a vending machine or an agent or associate thereof (e.g., a route driver or lessee of a vending machine). In some embodiments, an operator may also be associated with a server or controller and/or customer devices utilized to implement embodiments described herein. Operators may also or alternatively be associated with the manufacture and/or distribution of one or more products or services provided via a vending machine. According to some embodiments, an operator may be associated with restocking one or more vending machines (e.g., on a restock date and/or at a restock time).

As used herein, the terms “restock date”, “restock time”, “restock event” and “pick-up” may be used interchangeably and may generally refer to the time and/or date that a vending machine is scheduled to be (and/or is) serviced and/or restocked by an operator (or employee or agent thereof of a vending machine. Physical products (such as soda and snacks) may generally be re-filed locally, while services and digital media products may, according to some embodiments, be replenished and/or restocked remotely. Vending machines may be restocked at pre-defined intervals (e.g., once a week) and/or when one or more products are determined to have low or no remaining inventories.

Some embodiments described herein are associated with a “fill period” or “sales period”. As used herein, the terms “fill period” and “sales period” may be used interchangeably and may generally refer to the period of time between restocking events at a vending machine. The fill period may generally refer to a period associated with all products of a vending machine and/or may be defined in terms associated with a subset of products within the vending machine. In some embodiments, fill periods may be defined separately for each product and/or type of product provided via a vending machine.

Some embodiments herein are associated with a “feature” of a vending machine. As used herein, the term “feature” may generally refer to any functionality and/or capability of a vending machine. One feature may be the capability of processing cash transactions, for example, while another feature may be the ability to offer and/or sell package deals via the vending machine. Some features (such as features that may be enabled in response to favorable financing arrangement events) may comprise vending machine promotions, games, movie trailers, advertisements, music downloads, coupon acceptance abilities, and/or pre-paid unit account honoring capabilities.

As used herein, the term “promotion” may generally refer to a message that is output, regarding some product, distinct from a general offer to sell products from a vending machine at retail prices. For example, a promotion may comprise a message intended to increase machine profitability. Typically, a promotion allows customers to purchase one or more products under terms that are generally more favorable to the customer than standard retail terms (e.g., at prices less than or equal to the corresponding products full price(s), but greater than or equal to the corresponding product's minimum price(s)). Examples of such promotions are described in U.S. patent application Ser. No. 10/855,247 filed in the name of Walker et al. on May 27, 2004 and entitled “METHOD AND APPARATUS FOR MANAGING VENDING MACHINE OFFERS” and U.S. patent application Ser. No. 11/282,525 filed in the name of Walker et al. on Nov. 18, 2005 and entitled “SYSTEMS AND METHODS FOR VENDING PROMOTIONS”, the promotion concepts and descriptions of each of which are hereby incorporated by reference herein.

As used herein, the terms “package deal”, “combination deal”, “package promotion”, “combination promotion”, “combination product promotion”, “load-up deal”, “value combo deal”, and “combo deal” may be used interchangeably and may generally refer to any offer enabling a customer to purchase at least two products. In many embodiments the at least two products are sold for a single price. In many embodiments, the two products are dispensed to the customer essentially simultaneously (e.g., within seconds of each other). Typically, package offers are configured so the price of the at least two products is less than the sum of the prices of the two products, and thus the customer saves money compared to the sum of the individual component products' retail prices. According to some embodiments, customers may be presented with package offers representing one or more package instances determined by a vending machine.

As used herein the term “mystery promotion” may generally refer to any promotion offered to a customer where at least one product comprising and/or associated with the promotion is unknown, at the time of purchase, payment, and/or acceptance, to the customer. In some embodiments, the quantity of items purchased may be a mystery. While a typical package or combination offer may be comprised of a multiple component products, for example, a “mystery” version of the package offer may only comprise a single product (such as one more expensive product as opposed to two lower priced products). Similarly, a mystery promotion may simply comprise a single mystery product. In some embodiments, the type of product and/or products may be a mystery to the customer (e.g., the customer may simply be offered a mystery package for a certain price, without being privy to any more information regarding the package) and/or the specific product identity and/or brand of the product may be a mystery (e.g., the customer may be offered a mystery soda for a certain price, but may not know which brand of soda will be ultimately received by the customer). According to some embodiments, mystery promotions may comprise and/or be associated with upsells, alternate product offers, and the like.

Some embodiments described herein are associated with an “inventory group”, “inventory control group” or a “package group”. As used herein, the terms “inventory group”, “inventory control group”, and “package group” may be used interchangeably and may generally refer to any grouping, set combination, and/or other association of one or more products. An inventory group may include a single product, or more than one product. In many embodiments, a customer may select a component product from an inventory group. In certain proactive inventory grouping embodiments, pursuant to a package offer, customers may select at least two component products, a component product selected from each of at least two inventory groups, for a single price (e.g., a package price). In reactive inventory grouping embodiments, pursuant to a package offer, customers may select a second component product from an inventory group that is revealed after a first component product is selected from a first inventory group.

In one or more embodiments, inventory groups may be communicated to customers through colored LED devices located proximately to inventoried products (e.g., products in a “red” group may be communicated via proximately located red LED devices; products in a “green” group may be communicated via proximately located green LED devices). In proactive and reactive inventory grouping embodiments, inventory groups may be determined by a vending machine control system during a sales period. In some embodiments, inventory groups are not determined automatically (as in proactive or reactive inventory grouping embodiments), but are rather determined prior to a sales period by an operator or other person, and are stored (e.g., as rules in a database) accessible to a vending machine control system.

### III. Systems

A. Introduction

Generally, a vending machine in accordance with embodiments described herein may comprise a device, or communicate with a device (e.g., a server, a peripheral device, and/or a peripheral device server), configured to manage sales transactions with customers by, among other things, receiving payment from customers, controlling the pricing and/or distribution of goods and/or controlling entitlements to services. The vending machine may, in some embodiments, be in communication with one or more other vending machines, each of which may generally be associated with one or more operators. The vending machine operators may generally enter into one or more financing and/or contractual relationships (e.g., a franchise and/or similar relationship) associated with the vending machines.

Some embodiments described herein are directed to facilitating and/or managing such financing arrangements (and/or other arrangements) amongst a plurality of vending machines and/or operators (e.g., via a central and/or other controller). Financing parameters may be determined based on vending machine performance, for example, and/or multiple vending machines may be collectively managed for financing and/or other contractual purposes. In some embodiments, poorly performing vending machines may be offset by associated vending machines with better performance and/or one or more vending machine features may be remotely controlled to facilitate management of financing and/or other relationships involving the vending machines. Similarly, vending machine features may be activated and/or deactivated based on operator and/or vending machine performance. Such functionalities may, according to some embodiments, be effectuated via a controller in communication with one or more vending machines.

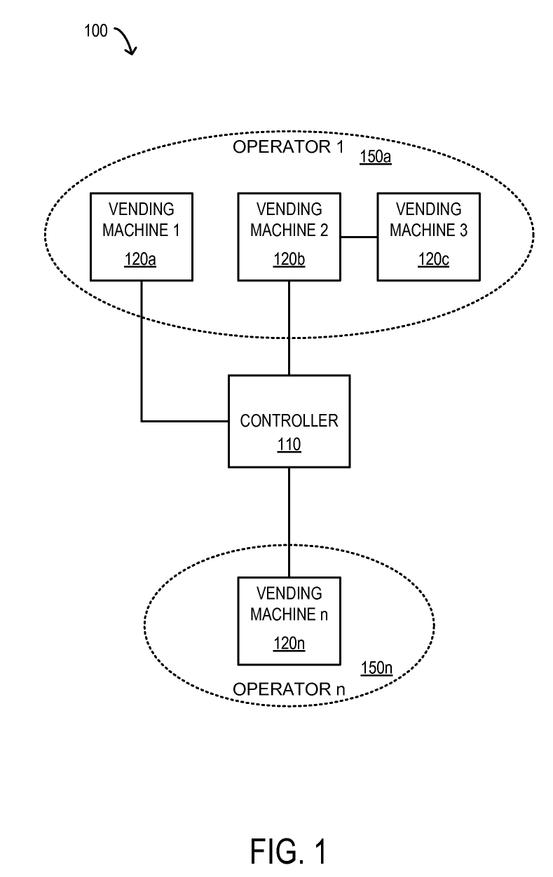

Referring initially to FIG. 1, for example, a block diagram of a system 100 according to some embodiments is shown. The system 100 may comprise, according to some embodiments, a controller 110 that may be in communication with a plurality of vending machines 120a-n. As shown for exemplary purposes in FIG. 1, a first vending machine 120a, a second vending machine 120b, and a third vending machine 120c may be associated with a first operator 150a. Any number of vending machines and/or operators may be included in the system 100. As shown, for example, an “n^{th}” operator 150n may be associated with an “n^{th}” vending machine 120n. As is exemplified by the first operator 150a, an operator 150 may be associated with a plurality of vending machines. Operators 150a-n may also, according to some embodiments, be associated with sub-operators and/or drivers or other employees (not explicitly shown). The first operator 150a may comprise a vending operations company that owns and/or operates the first, second, and third vending machines 120a-c, for example, that may employ any number of drivers and/or sub-operators to service, stock, and/or manage any or all of the individual machines 120a-c.

In some embodiments, the controller 110 may be in direct communication with the vending machines 120a-n. One or more vending machines 120a-n, such as the third vending machine 120c for example, may alternatively be in communication with the controller 110 via one or more other vending machines 120a-n (e.g., via the second vending machine 120b, as shown). Communications, as described herein, may also or alternatively be of any form or type that is or becomes known or practicable. Communications may, for example, be wired, wireless, direct, indirect, broadcast, intermittent, periodic, continuous, and/or any combination thereof. The vending machines 120a-n may, for example, only establish communications with the controller 110 on a scheduled (e.g., at a scheduled financing payment and/or fee payment date and/or time) and/or event-driven basis (e.g., after every sale or number of sales). Such communications may generally be implemented via any type, number, and/or configuration of network and/or networks (not explicitly shown) that are or become known or practicable.

In some embodiments, redundant network and/or communication connections (not explicitly shown) may be established between one or more of the vending machines 120a-n and the controller 110 (and/or with other vending machined 120a-n). A primary wireless connection, for example, may be supplemented and/or backed-up by a hardwired and/or landline connection. Should the wireless connection be interrupted, for example, the hardwired connection could then be used to ensure uninterrupted communications. In some embodiments, dual (or more) networks may be utilized to verify data integrity and/or to otherwise ensure secure transactions between the vending machines 120a-n and/or the controller 110. Transmission sent via a first network connection from the first vending machine 120a to the controller 110, for example, may be supplemented by an identical transmission sent via a second network connection. The transmission may then be compared and/or analyzed at the controller 110 (and/or at the first vending machined 120a) to verify that both signals are substantially identical. In such a manner, for example, any security and/or signal integrity issues may be readily identified. Such a process may also be implemented utilizing one or more cryptographic protocols to enhance secure transmissions. In some embodiments, a first portion of data may be encrypted via a first key and/or protocol and sent via the first network connection, while a second and/or remaining portion of the data may be encrypted via a second key and/or protocol and sent via the second network connection. The transmissions may also comprise instructions (e.g., encrypted instructions; such as encrypted utilizing a third protocol and/or key) indicating how the portions are to be properly combined, appended, and/or overlaid. Such a bifurcated encryption and transmission distribution strategy may provide enhanced vending machine communications security.

According to some embodiments, the controller 110 may be owned and/or operated by and/or otherwise associated with one or more entities. Such entities may, in some embodiments, comprise one or more of (i) a lender, (ii) a vending machine 120a-n manufacturer, (iii) a vending machine 120a-n retailer, (iv) a vending machine 120a-n renter, (v) a vending machine 120a-n service provider, (vi) a franchiser, (vii) a financial institution, (viii) a third-party, and/or (ix) any combination thereof. The controller 110 may, for example, be associated with an entity that facilitates and/or manages a financing and/or other contractual relationship involving any or all of the vending machines 120a-n. Such entities may generally be referred to herein as “controlling entities”. The operators 150 may contract with such a controlling entity, for example, to lease, purchase, finance, and/or otherwise operate the vending machines 120a-n provided by the entity associated with the controller 110.

In some embodiments, the controller 110 may be associated with multiple entities and/or may comprise a plurality of interconnected servers and/or controllers. In the case that a financial institution finances the first operator's purchase of the first vending machine 120a from a vending machine company, for example, the controller 110 may comprise a device owned and/or operated by the financial institution (e.g., to accept loan payments) and a device owned and/or operated by the vending machine company (e.g., to monitor and/or analyze the performance of the first vending machine 120a). In the case that electronic payment transaction associated with the vending machines 120a-n are conducted, the controller 110 may also or alternatively comprise a credit card, debit card, and/or other electronic payment server, such as a credit card authorization server, device, and/or network. The functionalities of such devices may also or alternatively, according to some embodiments, be performed by one or more separate devices (not shown) of the system 100.

B. Interactions

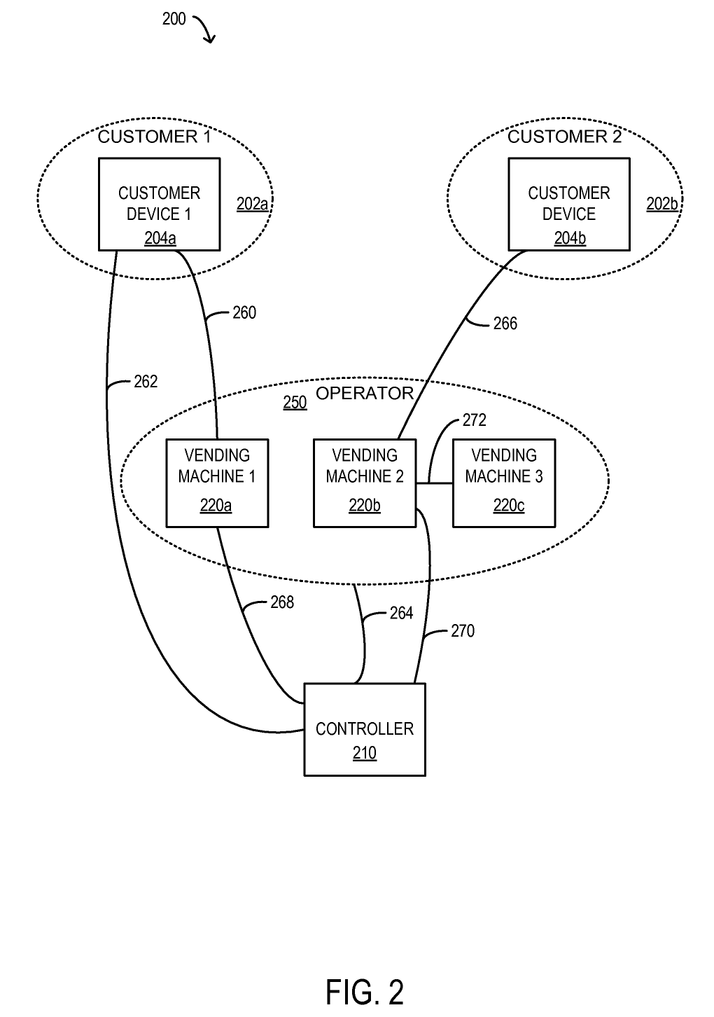

Referring now to FIG. 2, a block diagram of a system 200 according to some embodiments is shown. In some embodiments, the system 200 may be similar in configuration and/or functionality to the system 100 of FIG. 1. The system 200 may generally comprise one or more customers 202a-b operating and/or owning one or more customer devices 204a-b. The customers 202a-b and/or customer devices 204a-b may be in communication with a controller 210, one or more vending machines 220a-c, and/or one or more operators 250. Any or all of the components 210, 220, 250 of the system 200 may be similar in configuration and/or functionality of the similarly named and/or numbered components of the system 100 of FIG. 1. In some embodiments, fewer or more components and/or devices may be included in the system 200.

As shown in FIG. 2, a first customer 202a may utilize a first customer device 204a to communicate and/or interface with a first vending machine 220a (e.g., via a first communications path 260). In some embodiments, the first customer device 204a may comprise a PC, PDA, cell phone, and/or other computing and/or mobile computing device owned and/or operated by and/or otherwise associated with the first customer 202a. The first customer device 204a may, for example, comprise a cellular telephone utilized by the first customer 202a to transmit requests to the first vending machine 220a, receive offers from the first vending machine 220a, and/or to provide payment to the first vending machine 220a. According to some embodiments, the first customer device 204a may also or alternatively comprise a part, component, and/or portion of the first vending machine 220a and/or a peripheral device associated with the first vending machine. The first customer device 204a may comprise, for example, a touch screen interface and/or other input and/or output device associated with the first vending machine 220a that the first customer 202a may utilize to interact with the first vending machine 220a.

In some embodiments, the first customer 202a may purchase one or more products from the first vending machine 220a utilizing a form of electronic payment. Such electronic payment may generally be processed via the first vending machine 220a (e.g. via the first communications path 260) and/or may be processed by and/or through the controller 210 (e.g., via a second communications path 262). In electronic payment embodiments, the first customer device 204a may comprise an electronic payment mechanism and/or medium such as a credit card, debit card, stored-value card, and/or smart card, an/or a reader of such cards. In the case that electronic payments are made and/or facilitated via the controller 210 and/or via the second communications path 262, the vending machine operator 250 may not directly receive credit for such electronic payment. Instead of the operator 250 being required to interact with (and/or pay) a credit card service, for example, the controller 210 (and/or an entity associated therewith) may conduct such operations on behalf of the operator 250. In such embodiments, an amount based on electronic funds received from customers 202a-b via the controller 210 may be owed (e.g., by the controller 210 and/or associated entity) to the operator 250.

According to some embodiments, any amounts owed to the operator 250 and/or to individual vending machines 220a-c may be provided by the controller 210 via a third communications path 264 (shown in FIG. 2 as being directed to the operator 250). In some embodiments, such reimbursement funds may also or alternatively be provided to an operator device (e.g., separate from the vending machines 220a-c, such as a PC or cellular telephone; not shown) and/or to a third-party device (also not shown) such as a banking institution server capable of crediting amounts to one or more accounts associated with the operator 250. The controller 210 may also or alternatively interface with a third-party device such as a credit card server to facilitate credit-based transactions. Amounts may be charged and/or credited to a credit account associated with the operator 250, for example, via such a third-party device. In some embodiments, the third communications path 264 may also or alternatively be utilized to provide payment from the operator 250 to the controller 210 (and/or an entity associated therewith). The operator 250 may, for example, be required to pay a fee such as a location and/or rental fee associated with any or all of the vending machines 220a-c. In some embodiments, any fees or payments owed by the operator 250 (e.g., credit card payments and/or pre-paid unit account payments) may be compared and/or reconciled with any amounts owed to the operator 250 (e.g., monthly finance payments), such that a net payment amount may simply be transferred (e.g., via the third communications path 264) to whichever entity is appropriate and/or may be credited to any appropriate account. Any processes and/or actions associated with such reconciliations, payments, and/or payment computations may generally be referred to herein as a “settlement”. Such a settlement may be associated with and/or define, according to some embodiments, a settlement amount, a settlement entity, a settlement date, a settlement time, a settlement type, a settlement method, etc. any or all of which may govern how and/or when the settlement is to occur or be conducted.

In some embodiments, a second customer 202b may utilize a second customer device 204b to interface with a second vending machine 220b (e.g., via a fourth communications path 266). The second customer device 204b may, according to some embodiments, be similar in configuration and/or functionality to the first customer device 204a. The second customer device 204b, for example, may comprise a mobile device operated by the second customer 202b to effectuate a purchase of one or more products from the second vending machine 220b. In some embodiments, such as in the case that the second customer 202b utilizes cash payment to make a purchase at the second vending machine 220b, the second customer device 204b may comprise a monetary device and/or media such as a token, coin, cash bill, redemption ticket, etc.

According to some embodiments, the first and/or second vending machine 220a-b may communicate with the controller 210, e.g., via fifth and sixth communications paths 268, 270, respectively, to provide and/or receive information. The controller 210 may, for example, provide updated prices, advertising, revenue management rules, customer information (e.g., registered customer account information, subscription information, and/or membership information), product descriptions, promotions, promotional messages, payment authorizations, etc., to the first and second vending machines 220a-b. The first and second vending machines 220a-b may also or alternatively provide sales and/or customer information, available inventory information, available funds information, account information, payment authorizations, sensor information, etc., to the controller 210. Such communications may also or alternatively be conducted by the operator 250 (e.g., via an operator device) and/or between the operator 250 and the controller 210 (and/or an entity associated therewith).

In some embodiments, one or more vending machines 220a-c may also or alternatively communicate with each other. As shown in FIG. 2, for example, a third vending machine 220c may utilize a seventh communications path 272 to communicate with the second vending machine 220b. The second vending machine 220b may, according to some embodiments, facilitate and/or conduct communications between the third vending machine 220c and the controller 210. Any sales or available funds information from the third vending machine 220c, for example, may be relayed (e.g., utilizing the seventh communications path 272) via the second vending machine 220b to the controller 210 (e.g., utilizing the sixth communications path 270). In some embodiments, the second and third vending machines 220b-c may be grouped together such that the controller 210 may only receive aggregate information (e.g., via the sixth communications path 270) pertaining to all vending machines 220b-c in the group (which may simplify and/or facilitate processing and/or settlement at and/or via the controller 210).

Generally, the controller 210 may analyze and/or compile information received from the vending machines 220a-c to determine various metrics and/or values associated with settlement procedures and/or processes. In the case that fees payable by the operator 250 are determined based on performance of one or more of the vending machines 220a-c, for example, the controller 210 may utilize sales information received from the vending machines 220a-c to calculate and/or otherwise determine (e.g., lookup) fee amounts owed by the operator 250. The controller 210 may also or alternatively determine and/or calculate any amounts due to the operator 250, such as amounts associated with electronic payment transactions that the controller 210 and/or related entity conducted on behalf of the operator 250. According to some embodiments, such as in the case that fees are not based on vending machine performance, little or no information may be required to be transmitted from the vending machines 220a-c (e.g., the fees and/or other settlement or promotional parameters may be fixed). In any case, the controller 210 may reconcile any amounts owed to and/or by the operator 250 to determine a settlement amount payable to the operator 250 or payable to the controller 210 (and/or associated entity). The settlement amount may then, for example, be transferred between parties as is determined to be appropriate, such as by utilizing the third communications path 264.

In some embodiments, the settlement may be conducted individually for each of the vending machines 220a-c. Each vending machine 220a-c may be associated with an account that is debited and/or credited, for example, pursuant to settlement processes. Alternatively, any or all of the vending machines 220a-c may be grouped together, at least for settlement purposes, to minimize and/or reduce the number of transactions required to effectuate and/or complete settlement with the operator 250. The operator 250 may maintain a single financial account that is utilized as an operating account to fund fee payments, for example, and to which any credits for centrally processed electronic payments may be applied.

According to some embodiments, as described herein, the settlement may be based on various factors associated with the financing of the vending machines 220a-c by the operator 250 and/or may be conducted pursuant to various rules established as part of an agreement between the operator 250 and one or more entities associated with the controller 210. The performance of the operator 250 in providing payment for any applicable fees and/or the sales performance of one or all of the vending machines 220a-c may be utilized, for example, to define, set, schedule and/or otherwise determine various parameters associated with settlement. Further, the performance and/or actions of the operator 250 and/or the vending machines 220a-c may trigger various responses that alter the functionality of one or more of the vending machines 220a-c.

### IV. Methods

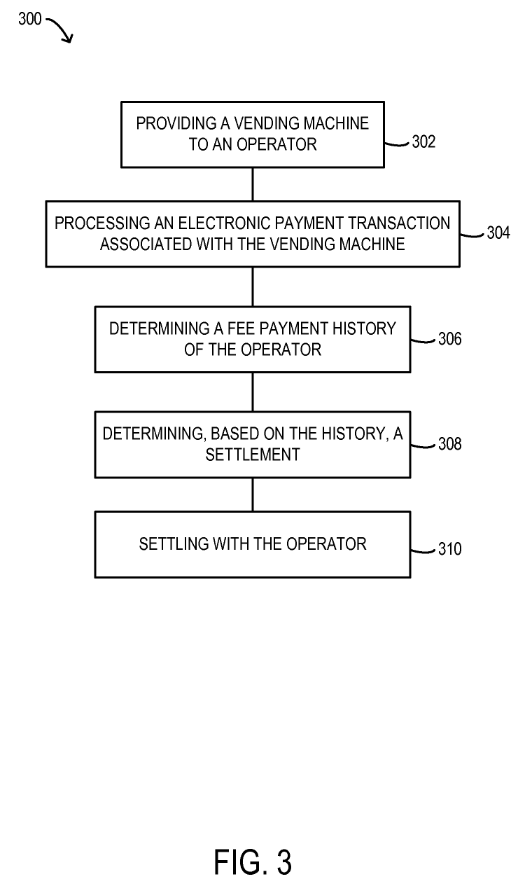

Turning to FIG. 3, a flow diagram of a method 300 according to some embodiments is shown. In some embodiments, the method 300 may be performed and/or implemented by and/or otherwise associated with any of the vending machines 120a-n, 220a-c and/or the controllers 110, 210 described in conjunction with FIG. 1 and/or FIG. 2. The flow diagrams described herein do not necessarily imply a fixed order to the actions, and embodiments may be performed in any order that is practicable. Note that any of the methods described herein may be performed by hardware, software (including microcode), firmware, and/or any combination thereof. For example, a storage medium may store thereon instructions that when executed by a machine result in performance according to any of the embodiments described herein.

According to some embodiments, the method 300 may begin by providing a vending machine to an operator, at 302. In some embodiments, the vending machine providing may also or alternatively simply be facilitated. Providing the vending machine may comprise, for example, (i) extending financing and providing the vending machine to the operator, (ii) just extending or arranging for financing to be extended to the operator, (iii) just providing the vending machine, or (iv) providing the vending machine and facilitating the financing (such as by processing a credit card transaction for the payment of the vending machine). A vending machine, such as the vending machines 120a-n, 220a-c of FIG. 1 and/or FIG. 2, may, for example, be made available to an operator (such as the operators 150a-n, 250 of FIG. 1 and/or FIG. 2) pursuant to an agreement such as a financing, franchise, lease, and/or other contractual agreement. In some embodiments, an entity such as a financier of an operator's vending machine purchase or lease may provide one or more vending machines to the operator and/or may arrange for such provision. In the case that the financier is not the vending machine manufacturer, for example, the financier may arrange for the manufacturer (and/or other entity such as a wholesaler or retailer) to provide the vending machine to the operator. According to some embodiments, the provision of the vending machine may include delivery and/or setup/installation of the vending machine. In some embodiments, such as in the case that the vending machine is purchased, rented, and/or leased from an entity having ownership rights in a proposed and/or current location of the vending machine, the provision of the vending machine to the operator may also or alternatively comprise providing the location in which to place and/or operate the vending machine. The provision, according to some embodiments, may comprise services and/or access to services that may be utilized to operate the vending machine (e.g., electricity, network and/or phone connections, wireless connections, electronic payment services, and/or fluid connections, hookups, or services). In some embodiments, the providing may comprise providing access, such as via an access code and/or key, to an existing and/or pre-placed vending machine.

In some embodiments, the providing of the vending machine may be preceded by and/or in accordance with one or more arrangements and/or contracts. The operator may acquire rights to operate the vending machine through, for example, one or more of a rental agreement, a purchase agreement, a lease agreement, a financing agreement, a franchise agreement, a license agreement, etc. The operator may finance a purchase of the vending machine through a controlling entity (e.g., that may be associated with and/or operate the controllers 110, 210 of FIG. 1 and/or FIG. 2), for example, that may either directly or indirectly provide the vending machine, vending machine location, and/or vending machine products, features, and/or promotions. In some embodiments, the controlling entity may manage the arrangement by implementing, facilitating, and/or being otherwise associated with the embodiments described herein. The controlling entity may also or alternatively provide advertising, product purchasing, research, analysis, electronic payment and/or processing, features, software, data storage, vending machine maintenance and/or stocking, and/or other services to the operator (either in addition or pursuant to the agreement).

According to some embodiments, a controller associated with the controlling entity may arrange, determine, facilitate, execute, and/or manage, supervise, or implement the agreement or creation of the agreement. The controller and/or controlling entity may define, negotiate, and/or otherwise determine, for example, one or more terms of the agreement such as, but not limited to: (i) a financing rate (e.g., an interest rate, such as an Annual Percentage Rate (APR)); (ii) a location fee (e.g., a flat fee, monthly location rental fee, and/or a fee based on vending machine and/or operator performance); (iii) a commitment period (e.g., loan and/or agreement length or timeframe); (iv) settlement terms and/or rules (e.g., settlement dates and/or amounts and/or rules governing the determination of such dates and/or amounts); (v) electronic payment processing rules and/or terms; (vi) sales rules and/or requirements (e.g., only sell Pepsi® products, don't sell water for less than one dollar ($1.00), maintain a certain profit margin and/or revenue rate, collect a certain amount of e-mail addresses of customers, and/or register a certain minimum amount of subscription or membership customers); (vii) franchise rules and/or requirements; and/or (viii) rules related to remote management of vending machine features in response to agreement conditions and/or events.

Once the vending machine is provided to the operator (e.g., at 302), the vending machine may initiate sales to consumers (although pre-placed and/or pre-existing vending machines may simply resume and/or continue sales to customers). Some customers may purchase products from the vending machine by utilizing cash payments, while others may utilize electronic payment features of the vending machine to provide electronic payment. In some embodiments, customers may also utilize a biometric device and/or code to indicate a vending machine account to the vending machine. Such a vending machine account may be linked to one or more financial accounts associated with the customer, such as a credit card account. The vending machine account may, according to some embodiments, be automatically funded by the credit card, such as upon a depletion of account funding (in terms of dollars, credits, units, etc.) below some pre-determined level. Examples of such vending machine accounts and associated mechanisms are described in International Application No. US 2004/041,561 filed in the name of Breitenbach et al. on Dec. 9, 2004 and entitled “PRODUCTS AND PROCESSES FOR ESTABLISHING MULTI-TRANSACTION RELATIONSHIPS WITH CUSTOMERS OF VENDING MACHINES”, the vending account concepts and descriptions of which are hereby incorporated by reference herein.

At 304, the method 300 may continue by processing an electronic payment transaction associated with the vending machine. A device such as the controller 110, 210 of FIG. 1 and/or FIG. 2, for example, may process electronic payments on behalf of the vending machine and/or the vending machine operator. In such a manner, for example, such payments may be managed, aggregated, and/or accumulated by the controller to reduce vending machine overhead, streamline communications and/or transaction processing, and/or to reduce credit card transaction costs (e.g., by aggregating vending machine transaction amounts—which are typically small dollar values—to larger dollar values). Cost savings and/or benefits may also or alternatively be realized by a controlling entity negotiating bulk discounts and/or rates for credit card transaction processing (e.g., that individual operators may not otherwise be capable of obtaining on their own). In some embodiments, electronic payments may be stored by the controller and periodically reconciled via a credit card authorization network. According to some embodiments, electronic payment transactions and/or account or payment authorizations or verifications may be conducted substantially simultaneously with a vending machine transaction (e.g., in real time).

The method 300 may, according to some embodiments, continue by determining a fee payment history of the operator, at 306. The controller may, for example, query a database (such as an operator and/or payment history database) to determine information associated with the operator's performance with respect to payment of vending machine location and/or financing agreement fees (e.g., financing, rental, lease, and/or franchise fees). In some embodiments, the fee payment history may be obtained from a third-party such as a financial institution and/or data management organization that stores and/or keeps track of such information (e.g., on behalf of the operator and/or controlling entity). According to some embodiments, the information may comprise detailed historical payment information (e.g., payment amounts, dates) and/or may comprise a simple flag and/or indicator representing the operator's payment history (e.g., “Y” and/or “Good” indicating a good payment history, and/or “N” or “Bad” indicating a poor payment history).

In some embodiments, the method 300 may continue at 308 by determining a settlement. Based on the operator's payment history, for example, a settlement associated with the operator may be determined (e.g., by a controller). According to some embodiments, the settlement may comprise any number of defined terms, conditions, metrics, and/or values. The settlement may comprise, for example, a definition of a settlement amount and/or a settlement date and/or time. In some embodiments, such a settlement amount may be at least partially based on the fee payment history of the operator. The better the operator's historical fee payment record and/or rating, for example, the higher the settlement amount may be. In some embodiments, the settlement amount may be primarily determined, defined by, and/or based on an amount owed to the operator for centrally processed electronic payment transactions. The settlement amount may also or alternatively be based on amounts associated with any fees owed by the operator. Any initial, primary, and/or base settlement amount may then be modified and/or structured based on the operator's payment history.

For example, an operator that has had a poor payment history (e.g., is often late with payments and/or has missed payments) may only receive a portion and/or percentage of the base settlement amount, which may effectively result in a poor payment history fee (as the operator will receive less settlement funds than otherwise may be provided). Similarly, operators with good or excellent payment records may receive even greater than one hundred percent (100%) of the base settlement amount, effectively resulting in a “bonus” or reward given to the operator for maintaining a good payment history. In some embodiments, instead of or in addition to varying (e.g., by an amount and/or percentage) the base settlement amount, the base settlement amount may be provided to the operator in multiple installments. Operators with poor payment history may be provided with the full settlement amount, for example, but the amount may be provided in four (4) equal installments spread out over a month's time (e.g., approximately one (1) installment per week). Operators with good payment histories may, according to some embodiments, have the entire settlement amount provided in a single, lump sum installment.

In some embodiments, the settlement date, time, and/or period may also or alternatively be defined and/or structured based on the operator's payment history. Any settlement installments may, for example, be scheduled based on the operator's performance. Operators with worse performance may have installments spread out over a longer time frame, for example, while operators with better performance may have installments spaced temporally closer together. According to some embodiments, even single settlement dates and/or periods associated therewith may be determined based on the operator's payment history. Operators with better payment histories may have settlement scheduled every day and/or week, for example, while operators with less impressive payment histories may have settlement scheduled once a month or at other less preferable times. In some embodiments, the determination of what dates, times, and/or periods may be desirable to an operator may be based on operator indications. An operator may provide, for example, an indication of which days of the week, times of day, days of the month, etc., may be preferred by the operator for settlement. The better the operator's payment performance is, for example, the closer settlement will be to the preferable time frame(s) indicated by the operator.

According to some embodiments, settlement may also or alternatively be based on factors associated with one or more vending machines and/or factors associated with the agreement between the operator and the controlling entity. Settlement dates and/or amounts may be based on (at least in part), for example, sales performance of a vending machine (or plurality of vending machines) associated with an operator, a number of vending machines associated with the operator and/or an amount of financing associated with the operator (e.g., metrics indicating a “volume” of financing participation), a length of commitment under the agreement, etc. In some embodiments, other agreement metrics may also or alternatively be determined and/or defined based on such considerations or factors. An interest rate associated with a financing, lease, and/or rental agreement may be based on vending machines sales performance (e.g., the better the performance, the better and/or lower the interest rate), for example, and/or rate of re-payment may be based on sales performance (e.g., an extra dollar amount may be contributed toward paying off principal as a reward for achieving certain sales goals) and/or characteristics.

In some embodiments, the rate of re-payment (e.g., of a financed amount) may be based on various sales characteristics such as a number of particular products sold. Certain products may, for example, be weighted more heavily toward an ability to re-pay a financed amount and/or to pay for a fee. According to some embodiments, a product that normally earns the vending machine (and/or operator) one dollar ($1.00), for example, may be set to instead earn an equivalent of two dollars ($2.00) toward re-payment of any amounts owed by the operator (e.g., a two-fold multiplier in the re-payment rate with respect to units of the product). In such a manner, for example, certain products may be promoted (e.g., by a controller, controlling entity, and/or third-party) by giving the operator an incentive to sell higher volumes of such products. The operator may, according to some embodiments, implement one or more vending machine promotions, sales, and/or utilize one or more vending machine features, advertising, and/or other techniques to promote such products to the consumer (e.g., in an attempt to more quickly and/or easily provide and/or earn payments for amounts owed by the operator).

While some embodiments are described with reference to comparatively better or worse operator payment histories and examples of settlements based thereupon, it should be understood that a continuum of payment history rankings and/or levels may be associated with a continuum of settlement options, types, and/or configurations. Various pre-defined payment history levels may be associated with one or more settlement amounts, dates, periods, and/or formulas, for example, and/or one or more formulas based on actual payment history metrics may be utilized to calculate values for settlement parameters (dates, amounts, etc.). In the case that formulas are utilized to calculate settlement values, such values may be rounded, truncated, and/or otherwise processed as is appropriate and/or practicable. According to some embodiments, multiple settlement values may be possible based on certain payment history parameters (how late payment has been, an average thereof, how much payment has been late, etc.). Quadratic formulas and/or multiple applicable formulas and/or rules may be utilized, for example, to determine settlement parameters. In such cases, settlement value selection rules and/or conflict resolution rules (such as to be applied in a case where two or more settlement values are determined to exist and/or conflict) may be applied to select one or more settlement values to apply to a settlement. Such rules may, according to some embodiments, be based on secondary considerations. Where an operator with poor payment performance but good vending machine performance qualifies for both an early settlement date (e.g., based on vending machine performance) and a late settlement date (e.g., based on payment history), for example, other metrics such as how many vending machines of the operators participate in a vending network may be utilized to choose one of the available options. In the case that the operator participates heavily in a vending network administered by a controller, for example, the early settlement date may be chosen (e.g., despite the operator's poor payment performance).

According to some embodiments, the method 300 may continue by settling with the operator, at 310. The controller may, for example, cause an appropriate amount of funds to be transferred to one or more accounts associated with the operator, and/or may simply credit an appropriate amount of funds to an account associated with an outstanding debt (e.g., associated with a purchase of a vending machine). In some embodiments, the controller may request an amount of funds owed by the operator (e.g., from the operator's account(s) and/or financial institution). In some embodiments, such as in the case that corrective measures (described herein) such as preventing operator access to a cash bin of the vending machine have been implemented, settling may comprise accessing the cash bin, removing some or all of any monetary amount contained by the cash bin, and/or depositing such amounts in one or more financial accounts, as is appropriate (e.g., if the operator is only deficient by one hundred dollars ($100) but the cash bin contains two hundred dollars ($200), the extra one hundred dollars ($100) may either be left in the cash bin for the operator, and/or provided to the operator—such as via a deposit into the operator's account).

In some embodiments, settling may be conducted in accordance with any settlement values, parameters, and/or conditions determined at 308. Settlement may comprise crediting a settlement amount to the operator on a settlement date, for example, where at least one of the amount and date are determined (e.g., at 308) based on the payment history of the operator. According to some embodiments, such as in the case that the controlling entity is involved in providing other services to the operator (e.g., services in addition to providing the vending machine and/or causing or arranging such provision), the settlement may comprise crediting the operator with an amount of goods and/or services. In the case that the controlling entity comprises a product manufacturer, wholesaler, and/or retailer, for example, the settlement may comprise providing a settlement amount equivalent of products with which the vending machine may be stocked. In some embodiments, the settlement may also or alternatively comprise stocking the vending machine and/or providing a settlement amount equivalent of other services such as wireless access, location rental fees, advertising space, etc. According to some embodiments, the controlling entity may provide products and/or services valued in excess of any determined settlement amount to promote acceptance of such goods or services by the operator (e.g., the operator foregoes cash settlement for an increased value of settlement goods and/or services).

Although most processes described herein are presented as being performed by and/or in associated with a controller, such processes may also or alternatively be performed by a vending machine and/or other operator device or peripheral device as described herein. Some or all of the data described as being stored, accessed, and/or determined may, for example, be stored, accessed, determined, and/or utilized by one or more vending machines and/or components thereof. Similarly, various processes may be performed in part by one device (such as a controller or first vending machine) and in part and/or remainder by another device (such as a second vending machine and/or a controller).

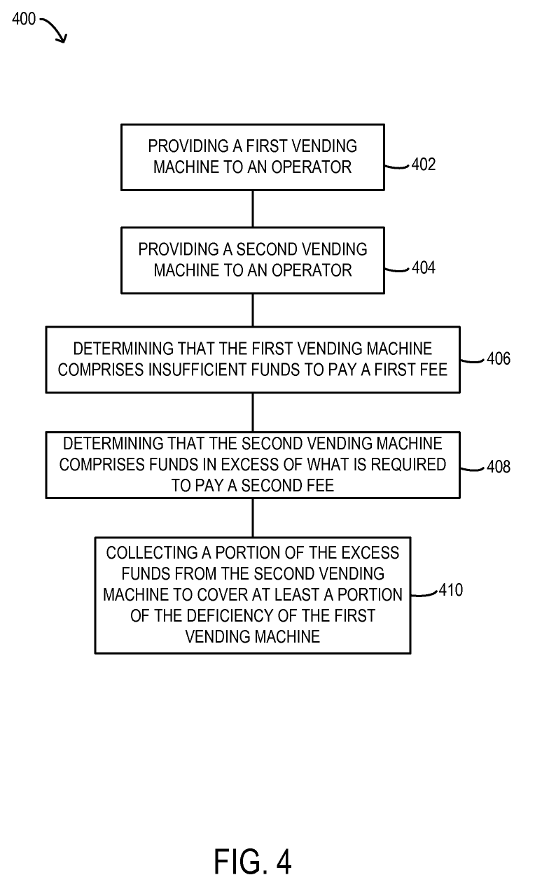

Turning now to FIG. 4, a flow diagram of a method 400 according to some embodiments is shown. In some embodiments, the method 400 may be performed and/or implemented by and/or otherwise associated with any of the vending machines 120a-n, 220a-c and/or the controllers 110, 210 described in conjunction with FIG. 1 and/or FIG. 2. In some embodiments, the method 400 may be associated with and/or performed in conjunction with the method 300 of FIG. 3. The method 400 may, for example, comprise a portion and/or embodiment associated with determining a settlement (e.g., at 308 of the method 300 of FIG. 3) and/or effectuating or conducting a settlement (e.g., at 310 of the method 300 of FIG. 3). According to some embodiments, the method 400 may be associated with conducting settlement and/or other vending agreement transactions based on metrics associated with a plurality of vending machines associated with an operator.

The method 400 may begin at 402, for example, by providing a first vending machine to an operator. The providing of the vending machine may, in some embodiments, be similar in nature to the provision described in conjunction with 302 of the method 300 of FIG. 3. A controlling entity such as a financier and/or vending network owner/entity may, for example, arrange for the operator to take possession of and/or acquire access to the first vending machine. According to some embodiments, the providing may be in response and/or pursuant to an agreement between the operator and the controlling entity. The method 400 may also comprise providing a second vending machine to the operator, at 404. This second providing may also or alternatively be similar to the providing at 302 of the method 300 of FIG. 3. In some embodiments, the first and second providing may comprise the same act, transaction, and/or procedure and/or may be conducted based on and/or pursuant to a single agreement. According to some embodiments, the first and second providing may be separate transactions and/or events and/or may be based on and/or conducted pursuant to two or more separate agreements. The first and second vending machines may be provided at a single location or may be provided at separate locations. Similarly, the first and second vending machines may comprise similar or different types or styles of vending machines. In some embodiments, the first vending machine may be provided by a first entity, while the second vending machine may be provided by a second entity. The controlling entity may comprise multiple entities, for example, and/or the controlling entity may arrange for the provision of the vending machines via first and second entities.

The method 400 may generally continue at 406 by determining that the first vending machine comprises insufficient funds to pay a first fee. A controller (and/or the first vending machine) may, for example, determine the first fee (such as a location rental or lease fee and/or a first financing fee), such as by accessing a database storing fee information associated with the operator and/or the first vending machine. The first fee may then be compared, for example, to an amount of funds determined to be available in the first vending machine (e.g., a cash and/or coin inventory, and/or funds owed to the operator that are attributable to the first vending machine). In the case that the first fee is larger than the available funds, the first vending machine may be determined to be deficient. The first fee, for example, may not be payable (at least in full) by the funds available from the first vending machine. In some embodiments, the deficiency may simply be determined by analyzing a deficiency flag stored in a database (e.g., “Y” indicating a deficiency and/or “N” indicating sufficient funds), such that the deficiency may have already been calculated and/or identified.

According to some embodiments, the method 400 may continue at 408 by determining that the second vending machine comprises funds in excess of a second fee. In some embodiments, the determining at 408 may be conducted substantially the same as the determining at 406, except that the available funds utilized in the determination is that of the second vending machine instead of the first vending machine. In other words, the determining at 406 may simply be repeated with respect to the second vending machine, at 408. In some embodiments, the determining at 408 may comprise a different process and/or procedure than that conducted at 406. In the case that the first fee and the second fee are the same fee (e.g., a single financing, network, and/or franchise fee), for example, the determining at 406 and/or at 408 may comprise comparing an aggregate of the available funds at the vending machines to determine a deficiency or excess (or sufficiency). According to some embodiments, the second fee may be determined based on the first fee and/or based on a amount that the first vending machine is deficient. The first fee may be indicative of a fee owed by the operator, for example, and the second fee may be indicative of an amount of the first fee that the first vending machine is not capable of paying (e.g., due to insufficient funds). According to some embodiments, either or both of the deficiency of the first vending machine and the excess funds amount of the second vending machine may be determined and/or stored.

In some embodiments, the method 400 may continue at 410 by collecting a portion of the excess funds from the second vending machine to cover at least a portion of the deficiency of the first vending machine. While the term “collecting” is utilized to generally describe the process at 410, actual functionality and/or procedures may be determined based on particular implementations. In the case that the “funds” represent monetary amounts attributable to and/or associated with each of the vending machines pursuant to settlement calculations and/or procedures (e.g., not actual cash resident in the vending machines), for example, the “collecting” may comprise debiting and/or subtracting an appropriate amount (or amounts) from such “funds”. In other words, collecting may, in some embodiments, simply comprise withholding an amount from the operator.

According to some embodiments, the process at 410 may comprise performing a calculation. The deficiency amount determined to be attributable to the first vending machine may, for example, be subtracted from the excess amount determined to be attributable to the second vending machine. In the case that the result is greater than or equal to zero (0), the deficiency amount may be deducted from the excess funds of the second vending machine to assist the first vending machine in paying the first fee. In such a manner, for example, multiple vending machines of an operator may conjunctively and/or cooperatively function to pay fees and/or otherwise participate in settlement procedures. In some embodiments, only a portion of the excess may be utilized to assist the first vending machine. Only a pre-determined fixed percentage such as fifty-percent (50%) and/or a fixed amount such as five dollars ($5.00) of the excess may be available for cross-machine cooperation, for example, as is or becomes desirable and/or practicable. In some embodiments, the excess amount may comprise a net excess amount, such that other expenses, fees, and/or amounts are deducted from the excess prior to being able to utilize any amount for cross-machine payment assistance. In the case that the result of the calculation is less than zero (i.e., a negative amount), the deficiency amount may be deducted from the excess to assist in paying the first fee, while any remaining amount owed with respect to the first fee may be charged to the operator. Any remaining amount may, in some embodiments, be further analyzed with respect to other vending machines (e.g., a third vending machine) to determine if such vending machines may be capable of paying the remaining amount of the first fee.

In some embodiments, both the first and second vending machines may be determined to be deficient. In such a case, the aggregate deficiency amount may be charged to the operator or may be determined to be payable by other vending machines. Similarly, both the first and second vending machines may alternatively be determined to comprise funds in excess of the first and/or second fees. In such a case, the excess may be payable to the operator (e.g., as a profit).

According to some embodiments, multiple vending machines may be conjunctively managed and/or analyzed to affect financing and/or other vending arrangements. In the case that various financing metrics are determined based on vending machine sales and/or customer registrations, for example, the sales and/or registrations may be aggregated and/or averaged (or otherwise analyzed) across a plurality of associated vending machines. In some embodiments, subsets of vending machines associated with an operator may be grouped together. The operator and/or controlling entity may, for example, group vending machines of the same type (e.g., beverage machines, snack machines, and/or Quickstore24™ machines), vending machines obtained pursuant to a specific agreement, vending machines located in a certain geographical area, vending machines located in the same type of locations, vending machines having certain functionalities, vending machines offering certain promotions, etc. According to some embodiments, the groups may be at least partially dynamic. In the case that one or more vending machine groups are defined based at least in part on a type of promotion offered by a vending machine, for example, a vending machine may change and/or switch groups based on which promotions are currently active at the machine.

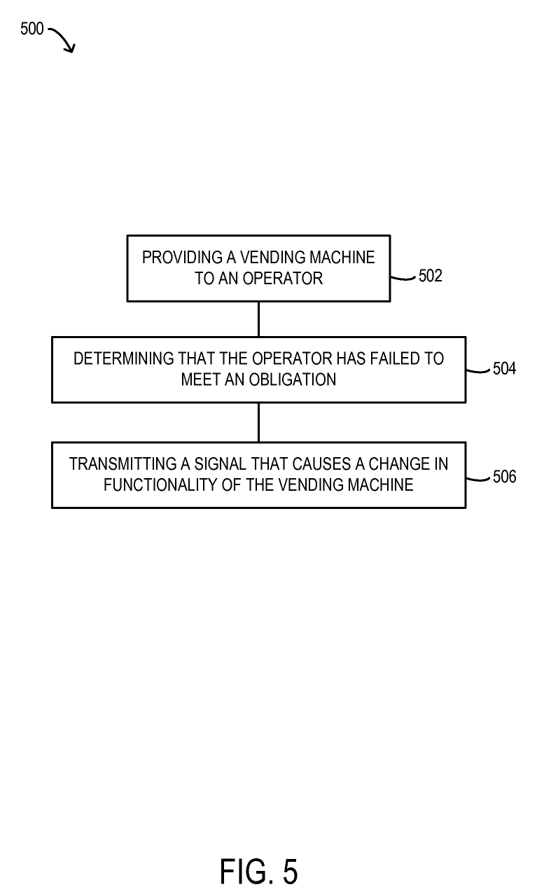

Referring now to FIG. 5, a flow diagram of a method 500 according to some embodiments is shown. In some embodiments, the method 500 may be performed and/or implemented by and/or otherwise associated with any of the vending machines 120a-n, 220a-c and/or the controllers 110, 210 described in conjunction with FIG. 1 and/or FIG. 2. In some embodiments, the method 500 may be associated with and/or performed in conjunction with any of the methods 300, 400 of FIG. 3 and/or FIG. 4 described herein. The method 500 may, for example, comprise a portion and/or embodiment associated with determining a settlement (e.g., at 308 of the method 300 of FIG. 3) and/or effectuating or conducting a settlement (e.g., at 310 of the method 300 of FIG. 3). According to some embodiments, the method 500 may be associated with altering and/or defining the functionality of a vending machine based on payment and/or other performance (e.g., franchise agreement terms such as trademark usage, brand standards and/or protocols, and/or reporting requirements) of an operator.

The method 500 may begin at 502, for example, by providing (and/or facilitating the provision of) a vending machine to an operator. The providing of the vending machine may, in some embodiments, be similar in nature to the provisions described in conjunction with any of 302, 402, and/or 404 of the methods 300, 400 of FIG. 3 and/or FIG. 4. A controlling entity such as a financier and/or vending network owner/entity may, for example, arrange for the operator to take possession of and/or acquire access to the vending machine. According to some embodiments, the providing may be in response and/or pursuant to an agreement between the operator and the controlling entity. In some embodiments, the vending machine may be configured and/or operable to change functionality based on signals received from another device (such as a controller or other vending machine).

According to some embodiments, the method 500 may continue by determining that the operator has failed to meet an obligation, at 504. A controller may determine the occurrence of a settlement and/or payment date, for example, and may determined that a fee or payment owed by the operator has not yet been received. Such a determination may occur, in some embodiments, upon the expiration of the payment date and/or upon the expiration of a grace period thereafter. In some embodiments, the delinquency of payment may be determined by receiving an indication from a third-party such as a financial institution, electronic payment processing center, check cashing and/or clearing center, etc. According to some embodiments, an indication of partial payment may be determined to comprise a delinquency. In some embodiments, the delinquency may be determined based on any amount (e.g., any portion of a payment that is due) that is not received when due. In some embodiments, a delinquency may be determined based on one or more parameters associated with a vending machine. In the case that certain metrics are required to be established and/or maintained with respect to a vending machined provided to the operator, for example, the failure to establish and/or maintain such metrics may be considered a delinquency. In other words, the delinquency need not be (or not entirely be) associated with an actual payment, but instead with any other obligation of the operator (e.g., pursuant to a vending agreement as described herein). The obligation that the operator fails to meet may be associated with and/or defined by, for example, terms of a franchise agreement, such as trademark usage, brand protocols, cleanliness protocols, etc.

At 506, the method 500 may continue by transmitting a signal that causes a change in functionality of the vending machine. Upon determination that the operator has failed to meet the obligation (e.g., at 504), for example, a controller may send a signal, command, and/or other information to the vending machine. In some embodiments, the signal and/or data may only be sent if a condition in addition to (or instead of) delinquency is determined. Delinquent payment (and/or other performance) may not by itself cause the signal to be transmitted, for example. The controller may determine, in some embodiments, one or more rules applicable to any agreement between the operator and the controlling entity, and may further determine of such rules are satisfied, violated, etc. For example, an operator may not be penalized by altering functionality of the vending machine pursuant to a late payment that is (i) only mildly late (e.g., a day or two late), (ii) of a low monetary amount (e.g., five dollars ($5.00)), and/or (iii) that is counter-weighted by the operator's otherwise generally good payment or other performance.

According to some embodiments, an operator may be associated with a payment history score. The score may be determined by the controller, for example, by weighting, aggregating, and/or otherwise analyzing the operator's payment and/or performance history. The scoring scheme may generally be established to promote and/or reward (e.g., with a good score) any number and/or type of aspects of the relationship between the operator and the controlling entity (and/or another entity). In the case that the operator consistently manages to register large numbers of new customers but also consistently pays agreement fees several weeks late, for example, the scoring scheme may be set to place a higher emphasis on registering customers (which may, for example, be ultimately a larger benefit to the controlling entity than receiving financing payments on time) than on timely payment. In some embodiments, a score associated with the operator may be determined, and/or the score may be compared to a pre-determined threshold to determine if vending machine functionality should be changed. A delinquent payment and/or performance event that drives the operator's payment history score below a certain level, for example, may trigger the transmission of the signal at 506.

The signal may comprise any form, quantity, and/or type of information that may be provided to the vending machine to cause the vending machine to change functionality. In some embodiments, the signal may comprise a command and/or instruction that: (i) disables a mechanism of the vending machine (e.g., a coin mechanism and/or cash payment mechanism, and/or a bin, door, and/or lock or latch); (ii) disables or enables promotions and/or promotional features of the vending machine (e.g., cash prizes, media provided at the vending machine, package deals, mystery promotions, and/or game features); (iii) outputs an indication of delinquency via the vending machine; and/or (iv) alters sales characteristics associated with one or more products sold via the vending machine.

The signal may be directed, according to some embodiments, to facilitating payment of any funds that may be delinquent and/or any fees associated with the delinquency. In the case that the operator is delinquent in paying a vending agreement fee, for example, the vending machine may be set to prevent distribution, redemption, and/or awarding of cash prizes at the vending machine. In such a manner, for example, the available funds of the vending machine may be at least partially preserved (e.g., since no cash will be dispensed to customers). Similarly, cash transactions may be set to only allow exact change. In other words, the vending machine may be disabled from dispensing cash or coin. The coin mechanism and/or bill validator of the vending machine may also or alternatively be disabled. This may, for example, force any customers to utilize electronic payment (credit card, debit card, stored-value and/or unit accounts, etc.) to purchase product at the vending machine. In some embodiments, since electronic payments may be conducted, facilitated, and/or managed by the controlling entity, the funds provided by the customers may effectively be re-routed to the controlling entity to pay any deficient amounts and/or associated fees. In some embodiments, the operator may also or alternatively be remotely locked out of the cash bin and/or inventory access of the vending machine. The operator may be denied access to the funds stored within the cash bin of the vending machine, for example, until the operator has paid any delinquent amounts and/or fees associated therewith. Similarly, the operator may be denied access to remove or add inventory of the vending machine be denying access to a service door and/or inventory storage area of the vending machine. According to some embodiments, the controlling entity and/or an agent thereof may also or alternatively remove cash, coin, and/or inventory from the vending machine to facilitate payment of any delinquent amounts owed by the operator.

Lockouts may be accomplished by any means that is or becomes known or practicable. In the case that an operator utilizes a key to open the cash bin and/or inventory storage area, for example, the lock that the key is operable to disengage may be electronically disabled and/or otherwise prevented from being disengaged (e.g., an electronic fail-secure lock mechanism may be isolated from electric power). In some embodiments, the key itself, such as in the case of a proximity card, vicinity card, and/or RFID card, may also or alternatively be disabled. The key may be disabled directly, such as by transmitting the signal to the key, for example, and/or may be disabled by restricting access to the electronic lock such as by removing an identifier associated with the key from an accessibility list. In some embodiments, a code and/or code sequence (such as a rotating code sequence) that the key may utilize to operate the lock may be, at least temporarily, changed.

According to some embodiments, such as in the case the operator utilizes a code (e.g., typed into a keypad or touch screen device) to access the vending machine, the signal may cause the code to be changed, preventing operator access to the vending machine. In some embodiments, an input mechanism utilized by the operator to indicate the code, such as a keypad, may also or alternatively be disabled (e.g., preventing receipt, by the vending machine, of the code). Such codes may also or alternatively comprise “keep alive” codes, such that the signal may actually provide a code to the operator, the code being required by the vending machine in order to continue functionality (partially or entirely). Examples of some uses of similar “keep alive” codes are described in U.S. Pat. No. 6,917,853 issued to Chirnomas on Jul. 12, 2005, the “keep alive” code concepts and descriptions of which are hereby incorporated by reference herein.

In some embodiments, a first lock mechanism that the operator utilizes to access the vending machine may be unaffected by any corrective action measures. A second lock mechanism may be associated with the vending machine, for example, and may engage to prevent access to the vending machine upon receipt of (and/or otherwise due to) the signal sent at 506. The second lock mechanism may comprise an electronic lock such as a deadbolt, for example, that may be engaged to override the effectiveness of the first lock utilized by the operator. According to some embodiments, the second lock mechanism may not comprise any external physical means via which the mechanism may be disengaged. To prevent the operator from attempting to utilize a key or other device to disengage the second lock mechanism, for example, the second lock mechanism may be inaccessible, hidden, and/or may lack an operator interface. In some embodiments, the second lock mechanism may comprise a fail-secure lock (and/or a lock that becomes fail-secure after receiving the signal and/or an indication thereof), such that in the case the operator unplugs the vending machine and/or otherwise isolates the second lock mechanism from power, the operator may still be prevented from accessing the machine. In some embodiments, the vending machine may comprise a battery backup and/or other alternative power source that may be utilized to maintain activation of the second lock mechanism in the case that the vending machine's main power supply is interrupted.

In some embodiments, an indication of delinquency may be output via the vending machine. To alert the operator and/or potential customers of the operator's delinquency, for example, the vending machine may output an audio and/or video message indicating the delinquency. In some embodiments, a portion of the vending machine may change color (e.g., such that a delinquency indication is illuminated) to indicate delinquency, and/or a graphical indication may be displayed. The graphical indication may be similar in design and/or functionality or effect to a “scarlet letter”, for example, and may be incorporated into or onto the cabinet, advertising display, and/or interface (e.g., a touch screen interface) of the vending machine. In such a manner, for example, the operator may be readily notified of the situation and/or may be motivated to rectify the situation to avoid embarrassment.

In some embodiments, sales characteristics may be changed as a corrective action. In order to facilitate payment and/or re-payment of any amounts owed by the operator (such as delinquent amounts), for example, prices, inventory groupings, package deals, mystery promotions, or even membership and/or subscription offers may be altered. In such a manner, for example, the controlling entity (and/or another designated entity) may effectively take control of the sales variables of the vending machine. Such control may be utilized, according to some embodiments, to increase revenues, increase profits, decrease inventory, preserve cash or coin, etc. According to some embodiments, the control may be utilized to institute a “going out of business” sale that adjusts promotions (e.g., promotion types, magnitudes, and/or frequencies) and/or prices in an attempt to deplete the vending machine of all available inventory (e.g., in preparation for removing the vending machine from a location and/or in preparation for restocking the vending machine by the controlling entity and/or agent thereof). Inventory groupings may also or alternatively be changed to alter sales at the vending machine in a manner that is desirable to the controlling entity (e.g., to increase revenue to facilitate quicker payment of delinquent fees).

According to some embodiments, other forms of corrective action may be implemented. In the case that a term of an agreement (such as a franchise agreement) is not met and/or is violated, for example, various functionality of one or more vending machines may be altered in response thereto. For example, pursuant to a vending agreement and/or franchise agreement, an operator and/or vending machine may be authorized to use a trademark, subject to certain criteria—such as a requirement that a competitor's brand of soft drink not be sold via the vending machine. In the case that it is determined that such a provision is violated, the corrective action may comprise restricting and/or preventing the use of the trademark. If a Pepsi® product is sold in a Coca-Cola® associated vending machine, for example, a Coca-Cola® logo displayed by the vending machine may be hidden, disabled, and/or may be otherwise restricted and/or altered in use. In some embodiments, the restriction may be temporary, intermittent, and/or based on various metrics associated with the vending machine.

In some embodiments, the corrective action may comprise a combination of corrective measures. In the example where a franchise agreement preventing sales of a competitor's products is violated, for example, trademark use may be restricted and sales characteristics of the competitor's product may be altered. The price of the competitors product at the vending machine may be substantially reduced (e.g., to “purge” the vending machine of the violating product) or substantially increased (e.g., to substantially prevent or inhibit sales of the competitor's product), for example. In some embodiments, units of the competitors product may be dispensed (and/or only dispensed) as a free and/or mystery product. According to some embodiments, a free unit of the competitor's product may be dispensed along with any purchased unit of a corresponding permitted product (e.g., a free unit of Pepsi® may be dispensed with every purchase of a unit of Coca-Cola®). In some embodiments, such a pairing of competing products may be promoted and/or advertised as a “taste test”. A touch screen of the vending machine may display a message, for example, stating “We think you will enjoy the Coca-Cola® you purchased so much, that we are giving you a FREE unit if Pepsi® to compare!” Similarly, customer feedback may be requested in association with such a corrective action so that actual taste test data may be recorded. In some embodiments, any benefit managed to be realized from the violation of the competitor product stocking agreement may be credited toward the operator and/or may count toward disabling active corrective actions. In other words, if the end result is positive, the operators violation may be forgiven, not recorded (e.g., in the operators history file or database record), and/or at least partially mitigated.

In some embodiments, such as in the case that operator payment history scores are utilized to determine whether to send the signal at 506, the score may also be utilized to determine which signal should be sent and/or to otherwise determine how the functionality of the vending machine should be changed. Different scoring levels may be implemented, for example, each level being attributed to (and/or capable of triggering) one or more corrective actions. In the case that the operators score falls below a first threshold, for example, the signal may comprise a command that disables cash prizes from being dispensed and/or awarded via the vending machine. In the case that the operators score falls below a second threshold, the signal may comprise a command that causes the coin acceptance mechanism of the vending machine to become inoperable (and outputs a message via the vending machine alerting customers of the inability to accept cash and/or coin). In the case that the operators score falls below a third threshold, the signal may comprise a command that causes prices of one or more products to be reduced (e.g., to clear inventory, increase revenue, and/or increase profit). And so on, as is or becomes desirable or practicable. In some embodiments, the tiered and/or hierarchical corrective actions may be implemented separately. According to some embodiments, such corrective actions may be cumulative. Upon the operator's score degrading to the third threshold, for example, each of the disabling of cash prizes, disabling of the coin mechanism, and lowering product prices may occur (e.g., pursuant to the signal transmitted at 506). In some embodiments, the various corrective actions may be at least partially mutually exclusive.

In some embodiments, multiple vending machines may be involved with and/or associated with corrective actions. In the case that one vending machine is determined to be realizing poor performance, for example, one or more other vending machines may be altered (e.g., in terms of functionality and/or settings) to compensate for the poorly performing (e.g., “bad”) machine. In other words, even though only a first vending machine may be generally subject to corrective measures due to poor performance and/or delinquent fees (e.g., fees attributable to the first vending machine), other vending machines may also (or alternatively) manipulated (e.g., by a controller) to facilitate remediation of any determined deficiencies. In some embodiments, such multi-machine tactics may be utilized preemptively. While settlement and/or performance analysis may occur at pre-scheduled intervals such as once a month, for example, vending machine performance may be monitored and/or evaluated at various times between settlement and/or general analysis periods. A week prior to a scheduled settlement, for example, vending machine performance for each machine of a plurality of networked machines may be determined. In the case that any machine is determined to be at risk of being non-compliant with respect to one or more performance goals or obligations, such as based on current metrics and estimated or projected metrics, then corrective actions may be preemptively implemented or suggested to avoid issues that may affect settlement.

While many embodiments are described with respect to disabling features of the vending machine and/or locking or preventing access to portions thereof, many embodiments are directed to activating vending machine functionality and/or allowing or providing access to the vending machine. While the signal transmitted at 506 may disable certain vending machine functions, for example, it may also activate, re-activate, and/or initialize vending machine functions. In the case that a function has been disabled due to delinquent payment, for example, and payment is then acquired by the controlling entity (e.g., from the operator and/or by manipulating one or more vending machines), a second signal may be transmitted to reverse a disablement of vending machine features. According to some embodiments, feature disablement may be associated with implementation periods. Upon the disablement of a vending machine's coin mechanism, for example, a timer may initiate. In the case that the timer reaches an end to a pre-determined time period, the feature (e.g., the coin mechanism) may be automatically re-activated. The signal sent at 506 (and received by the vending machine) may, for example, be self-expiring. In some embodiments, activation signals may otherwise by utilized.

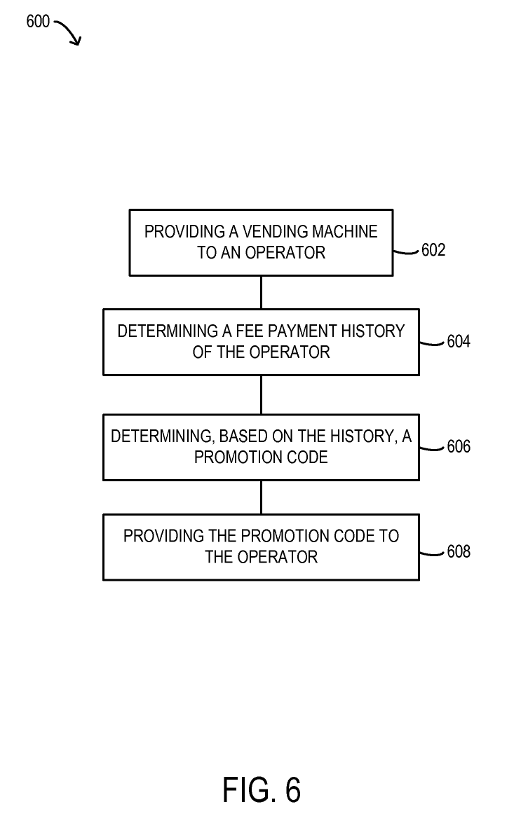

Turning to FIG. 6, for example, a flow diagram of a method 600 according to some embodiments is shown. In some embodiments, the method 600 may be performed and/or implemented by and/or otherwise associated with any of the vending machines 120a-n, 220a-c and/or the controllers 110, 210 described in conjunction with FIG. 1 and/or FIG. 2. In some embodiments, the method 600 may be associated with and/or performed in conjunction with any of the methods 300, 400, 500 of FIG. 3, FIG. 4, and/or FIG. 5 described herein. The method 600 may, for example, comprise a portion and/or embodiment associated with determining a settlement (e.g., at 308 of the method 300 of FIG. 3) and/or effectuating or conducting a settlement (e.g., at 310 of the method 300 of FIG. 3). According to some embodiments, the method 600 may be associated with rewarding good performance and/or payment history by providing feature and/or promotion activation codes.

The method 600 may begin at 602, for example, by providing a vending machine to an operator. The providing of the vending machine may, in some embodiments, be similar in nature to the provisions described in conjunction with any of 302, 402, 404, and/or 502 of the methods 300, 400, 500 of FIG. 3, FIG. 4, and/or FIG. 5. A controlling entity such as a financier and/or vending network owner/entity may, for example, arrange for the operator to take possession of and/or acquire access to the vending machine. According to some embodiments, any or all of the methods and processes described herein may be conducted without necessarily providing the vending machine to the operator. As various entities may be involved in different aspects associated with the implementation of vending agreements, for example, a first entity may provide the vending machine while a second entity may conduct other portions of the methods and processes described herein. In some embodiments, the vending machine operator may also or alternatively also be in possession of the vending machine and/or may otherwise already have access thereto. In such a case, for example, the controlling entity (and/or other entities) implementing various procedures herein may not need to provide the vending machine to the operator. The vending agreement, for example, may be associated with managing vending machine activity, without being associated with vending machine financing and/or vending machine procurement.

According to some embodiments, whether the vending machine is explicitly provided or arranged to be provided to the operator (e.g., at 602), the method 600 may continue by determining a fee payment history of the operator, at 604. In some embodiments, this determination may be similar to the determination of the operator's fee history at 306 of the method 300 of FIG. 3. The vending machine, controller, and/or other device may access a fee payment history database and/or memory, for example, to determine parameters associated with the operators historic performance in paying one or more fees pursuant to a vending agreement. As described herein, the operator's payment history may be analyzed and/or may be represented by a status identifier (e.g., “good”, “bad”), a simple flag (e.g., “Y” for good payment history), and/or a score (e.g., scores from eighty (80) to one hundred (100) may indicate a first category, class, and/or tier of payment history performance). In some embodiments, instead of or in addition to the fee payment history, other performance characteristics of the operator and/or vending machine(s) may be determined (such as the operator's history of compliance with one or more vending agreement terms or conditions and/or a vending machine's performance with respect to sales goals).

The method 600 may continue, in some embodiments, by determining a promotion code at 606. A promotion code may be retrieved from a memory, for example, and/or may be received from another device. In the case that a controller determines the promotion code, the code may be received from a third-party promotion provider, for example, and/or may be queried from a database by utilizing an applicable query algorithm. In some embodiments, the promotion code may be determined by the vending machine and/or may be determined by another device such as a peripheral device, a restocking device, etc. Promotion codes may generally comprise codes, keys, and/or hash values that are operable to cause a vending machine to activate, initiate, and/or offer one or more promotions. Upon receiving an indication of a promotion code, for example, the vending machine may activate a promotion associated therewith. In some embodiments, the promotion code and/or indication thereof may comprise an indication of one or more parameters associated with the promotion. In the case that the promotion is a particular package deal offered for a discounted price, for example, the code and/or associated indication may comprise an indication of the discounted price, number of package deal instances to be offered and/or sold, product identifiers to be associated with the packages, etc.

According to some embodiments, the promotion code may be determined based at least in part on the payment history (or other performance characteristics) of the operator (e.g., determined at 604). Promotion codes may, for example, be associated with various levels, classes, categories, and/or scores or score ranges representing payment history of the operator. In some embodiments, more valuable and/or desirable promotion codes may be associated with higher or better payment history performance. Promotion codes may be ranked and/or classified, for example, such that at least one promotion code may be associated with at least one type, quality, and/or class of payment history data. According to some embodiments, promotion codes may be ranked and/or weighted based on expected value metrics. A known and/or estimated take rate for a particular promotion may be analyzed with respect to product and/or other sales metrics, for example, to determine how much revenue, profit, and/or other benefits may be realized due to any given promotion. A promotion code associated with the promotion may then be ranked according to the expected value of the associated promotion. In the case that multiple promotions are associated with a given promotion code, the maximum, minimum, average, and/or other analytic metric associated with the expected value may be utilized to rank, score, and/or weight the promotion code. Higher ranked, scored, and/or weighted promotion codes may then be determined to be associated with higher ranked, tiered, scored, classified, and/or weighted payment history data (and/or operator performance data or vending machine performance data).

According to some embodiments, promotion codes may be determined randomly and/or via round-robin or other selection methods (e.g., selection from a plurality of available promotions and/or promotion codes). The determination of the promotion code at 606 may, according to some embodiments, be performed periodically, randomly, and/or upon the occurrence of one or more events. The determining may be scheduled to coincide with and/or be part of, for example, a settlement process pursuant to a vending agreement. A random number generator may then be utilized, for example, to determine whether 606 will be conducted. In other words, some operators may qualify for a determination of promotion codes upon settlement (and/or the occurrence of other events), while others may not. In some embodiments, 606 may only be conducted for operators associated with payment histories (and/or vending machine performance) that meets or exceeds certain pre-determined performance thresholds.

At 608, the method 600 may continue to provide the promotion code to the operator. In some embodiments, the providing may only occur for operators that have achieved certain performance (payment and/or vending sales) goals and/or may occur pursuant to a random selection. Even in the case that the promotion code is determined at 606, for example, the promotion code may not be provided to the operator unless the operator qualifies for the code. A random number associated with the operator may be generated to indicate random qualification, for example, and/or various performance metrics associated with the operator may be compared to pre-determined thresholds to define qualification.

According to some embodiments, the code may be provided directly to the operator, such as via a device (e.g., cellular telephone, PDA) associated with the operator, so that the operator may then provide the code to the vending machine (e.g., to activate features and/or promotions). In some embodiments, the code may be provided to the operator by transmitting the code to the vending machine. The vending machine may then automatically activate and/or implement the promotion, or the operator may be required to setup or initialize the promotion. In some embodiments, such as in the case that the code is sent directly to the vending machine to activate the associated functionality, the operator may be notified that the functionality has been activated (or will be activated). In such a manner, for example, the operator may be notified of the award of the code and/or of the activation of the functionality.

### V. Data Storage Structures

Some embodiments may be implemented using one or more databases, data stores, flat files, matrices, and/or lookup tables. It should be noted that individual database files and/or tables may be stored on different servers (e.g., located on different storage devices in different geographic locations, such as on one of the peripheral devices, a controller, a peripheral device controller, and/or any combination thereof, on different memory devices (e.g., separate and/or mirrored hard drives, RAM, ROM), via one or more vending machines, and/or on different partitions and/or sectors of a memory device. Data storage structures described and/or represented herein may generally be presented in exemplary form and/or configuration. Any alternative and/or additional forms or configurations that are or become known or available may be implemented according to some embodiments. Similarly, while exemplary data fields and/or data may be represented for exemplary purposes, other data fields and/or data may also or alternatively be utilized in accordance with some embodiments.

A. Operator Database

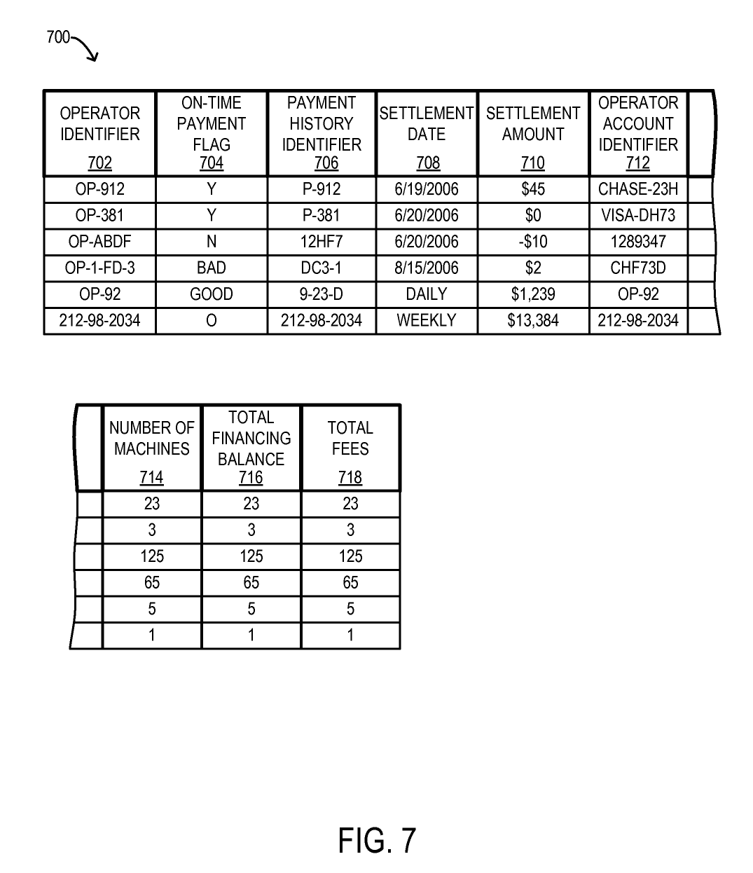

Turning to FIG. 7, a data table diagram illustrating an example data structure 700 according to some embodiments is shown. The exemplary data structure 700 may, in some embodiments, include a number of example records or entries, each of which may be associated with an operator of a vending machine. The exemplary data structure 700 may comprise fewer or more entries, as is or becomes desirable or practicable (e.g., one or more entries for every operator associated with a controlling entity).

The exemplary data structure 700 may also generally define fields for each of the entries or records. The fields may include, for example: (i) an operator identifier field 702 (e.g., that uniquely identifies an operator); (ii) an on-time payment flag field 704 (e.g., that indicates a status, class, or level associated with the operator's historic payment and/or other performance); (iii) a payment history identifier field 706 (e.g., that uniquely identifies one or more records in a payment history table); (iv) a settlement date field 708 that identifies a date and/or time during which a settlement is scheduled (and/or was performed); (v) a settlement amount field 710 that indicates an amount associated with a settlement; (vi) an operator account identifier field 712 (e.g., that indicates one or more accounts associated with the operator); (vii) a number of machines field 714 (e.g., that indicates how many vending machines are associated with the operator and/or that are associated with the operator and part of a vending machine network); (viii) a total financing balance field 716; and/or (ix) a total fees field 718.

The exemplary data structure 700 may be accessed by various devices and/or for various purposes. For example, a processor of a vending machine (e.g., the vending machines 120, 220 of FIG. 1 and/or FIG. 2) and/or a controller (e.g., the controller 110, 210 of FIG. 1 and/or FIG. 2) may access the exemplary data structure 700 to determine a payment history of an operator. In another example, the processor of the vending machine or a processor of a peripheral device or controller may access the exemplary data structure 700 to (i) identify an operator, (ii) determine an amount of fees an operator owes, (iii) determine when to initiate and/or conduct settlement with an operator, (iv) determine how much to settle with an operator for, and/or (v) determine an operators financing and/or network commitment and/or participation. According to some embodiments, alternative or additional fields (not shown) may include, for example, a controlling entity field, a vending agreement identifier field, operator contact information fields, operator device identifier fields, etc.

In some embodiments, the exemplary data structure 700 may store information associated with more than one controlling entity and/or more than one vending agreement or network. This may occur, for example, in the case that the exemplary data structure 700 is stored in a controller (such as the controller 110, 210 of FIG. 1 and/or FIG. 2), a peripheral device controller, and/or a peripheral device that is associated with more than one controlling entity and/or with more than one vending agreement. A controller may store the exemplary data structure 700 on behalf of multiple entities, for example, and/or a single entity may enter into numerous vending agreements with multiple operators. In such embodiments, the exemplary data structure 700 may store an entity and/or agreement identifier in association with one or more records, as is desired or practicable.

B. Payment History Database

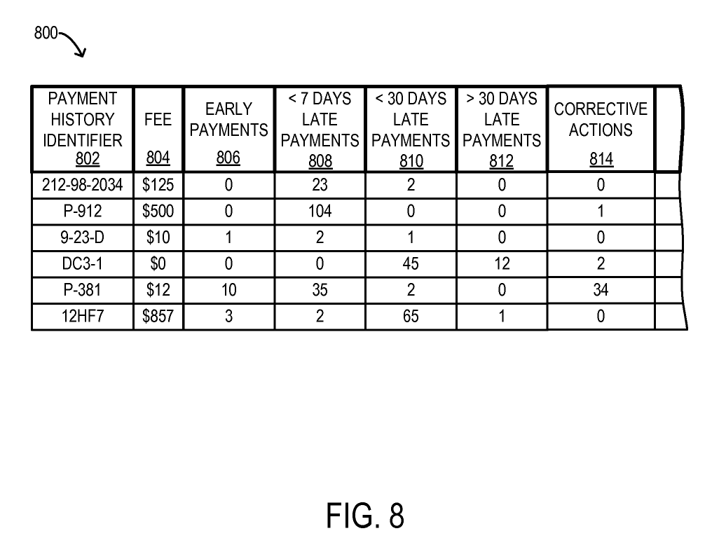

Turning to FIG. 8, a data table diagram illustrating an example data structure 800 according to some embodiments is shown. The exemplary data structure 800 may, in some embodiments, include a number of example records or entries, each of which may be associated with a payment history. Each payment history may be associated with one or more operators. The exemplary data structure 800 may comprise fewer or more entries, as is or becomes desirable or practicable.

The exemplary data structure 800 may also generally define fields for each of the entries or records. The fields may include, for example: (i) a payment history identifier field 802 (e.g., that uniquely identifies a payment history); (ii) a fee field 804 (e.g., that indicates a fee amount for which payment was due and/or received); (iii) an early payments field 806 (e.g., that provides a count of how many times and/or how often an operators payments have been early); (iv) a “<7 Days Late” payments field 808 (e.g., that provides a count of how many times and/or how often an operator's payments have been less than seven (7) days late); (v) a “<30 Days Late” payments field 810 (e.g., that provides a count of how many times and/or how often an operator's payments have been less than thirty (30) days late); (vi) a “>30 Days Late” payments field 812 (e.g., that provides a count of how many times and/or how often an operator's payments have been more than thirty (30) days late); and/or (vii) a corrective actions field 814 (e.g., that indicates how many times and/or how often a vending machine associated with the operator has been manipulated to alter functionality due to delinquent payments).

The exemplary data structure 800 may be accessed by various devices and/or for various purposes. For example, a processor of a vending machine (e.g., the vending machines 120, 220 of FIG. 1 and/or FIG. 2) and/or a controller (e.g., the controller 110, 210 of FIG. 1 and/or FIG. 2) may access the exemplary data structure 800 to determine a payment history of an operator. In another example, the processor of the vending machine or a processor of a peripheral device or controller may access the exemplary data structure 800 to (i) determine a payment history class, tier, status, and/or quality of an operator, (ii) determine an amount and/or type of corrective actions that have been utilized with respect to an operator (e.g., a corrective action history), and/or (iii) determine a late payment rate and/or score (e.g., an amount of fees weighted by the payment history). According to some embodiments, alternative or additional fields (not shown) may include, for example, a cash bin lockout field, an inventory access lockout field, a delinquency indication output field, a sales characteristic alteration field, a payment history class, tier, score, and/or rating or quality field, a payment status field, etc.

C. Payment Status Database

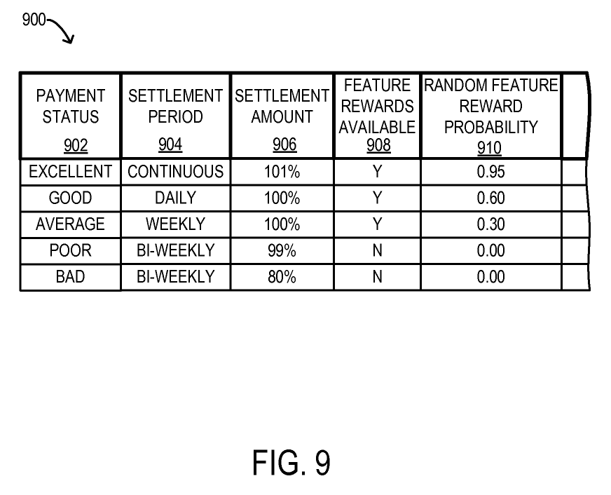

Turning to FIG. 9, a data table diagram illustrating an example data structure 900 according to some embodiments is shown. The exemplary data structure 900 may, in some embodiments, include a number of example records or entries, each of which may be associated with a payment status. Each payment status may generally be associated with various parameters such as various settlement parameters. The exemplary data structure 900 may be utilized, for example, to determine one or more settlement parameters based on a payment history status. While payment history “status” is presented as an example metric representing payment histories, as described herein, payment histories may also or alternatively be represented by and/or associated with classes, qualities, tiers, and/or scores, as is or becomes desirable or practicable. The exemplary data structure 900 may also generally comprise fewer or more entries, as is or becomes desirable or practicable.

The exemplary data structure 900 may define fields for each of the entries or records. The fields may include, for example: (i) a payment status field 902 (e.g., that indicates a payment status, class, tier, quality, score, and/or other metric); (ii) a settlement period field 904 (e.g., that indicates a type of settlement period associated with a payment status); (iii) a settlement amount field 906 (e.g., that indicates a percentage, portion, and/or ratio of a settlement amount that is associated with a payment status); (iv) a feature rewards available field 908 (e.g., that indicates whether vending machine features provided as payment history rewards may be available in association with a payment status); and/or (v) a random feature reward probability field 910 (e.g., that indicates a probability of receiving a random reward).

The exemplary data structure 900 may be accessed by various devices and/or for various purposes. For example, a processor of a vending machine (e.g., the vending machines 120, 220 of FIG. 1 and/or FIG. 2) and/or a controller (e.g., the controller 110, 210 of FIG. 1 and/or FIG. 2) may access the exemplary data structure 900 to determine a settlement parameter based on an operator's payment history and/or status. In some embodiments, the processor of the vending machine or a processor of a peripheral device or controller may access the exemplary data structure 900 to (i) determine a settlement date upon which a settlement should be conducted, (ii) determine a settlement amount that should be applied during the settlement, (iii) determine if rewards are available to offer to an operator associated with a particular payment status, and/or (iv) determine an expected value of any potential and/or actual rewards (e.g., by utilizing the random reward probability stored in the random feature reward probability field 910). According to some embodiments, alternative or additional fields (not shown) may include, for example, a feature identifier, a promotion identifier, an available promotions field, an available corrective actions field, etc.

D. Product Database

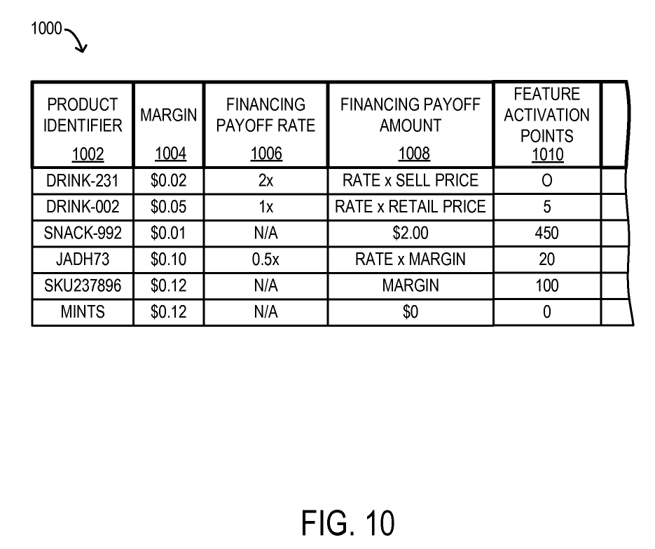

Turning to FIG. 10, a data table diagram illustrating an example data structure 1000 according to some embodiments is shown. The exemplary data structure 1000 may, in some embodiments, include a number of example records or entries, each of which may be associated with a product (such as products offered for sale via a vending machine). Each product may generally be associated with various sales characteristics and/or metrics and/or with various vending agreement rules. The exemplary data structure 1000 may be utilized, for example, to determine agreement and/or financing parameters based on products sold, stocked, remaining, and/or otherwise associated with a vending machine (or plurality of vending machines). The exemplary data structure 1000 may also generally comprise fewer or more entries, as is or becomes desirable or practicable.

The exemplary data structure 1000 may generally define fields for each of the entries or records. The fields may include, for example: (i) a product identifier field 1002 (e.g., that uniquely indicates a product offered for sale by a vending machine), (ii) a margin field 1004 (e.g., that indicates a profit margin associated with a product); (iii) a financing payoff rate field 1006 (e.g., that indicates a rate at which a product contributes to debt re-payment and/or fee payment); (iv) a financing payoff amount field 1008 (e.g., that indicates an amount that a product contributes toward payment of a fee and/or re-payment of a debt); and/or (v) a feature activation points field 1010 (e.g., that indicates a number of reward points associated with a product).

The exemplary data structure 1000 may be accessed by various devices and/or for various purposes. For example, a processor of a vending machine (e.g., the vending machines 120, 220 of FIG. 1 and/or FIG. 2) and/or a controller (e.g., the controller 110, 210 of FIG. 1 and/or FIG. 2) may access the exemplary data structure 1000 to determine a settlement parameter, payment, and/or reward based on a number and type of products sold, stocked, and/or otherwise associated with a vending machine. In some embodiments, the processor of the vending machine or a processor of a peripheral device or controller may access the exemplary data structure 1000 to (i) determine an amount of funds and/or funds equivalents available at a vending machine, (ii) determine a loan and/or debt payoff or payment amount, (iii) determine a fee payment, (iv) determine whether a product promotion and/or feature reward has been earned (e.g., by determining that a minimum number of feature activation points have been earned), and/or (v) determining a settlement parameter (e.g., how much an operator owes and/or is owed). According to some embodiments, alternative or additional fields (not shown) may include, for example, a product type field (e.g., drink, snack), a product group field (e.g., low margin snacks, poor sellers, drinks, snacks, a first inventory group, a second inventory group), an available quantity field, a position identifier (e.g., row, column), etc.

E. Vending Machine Database

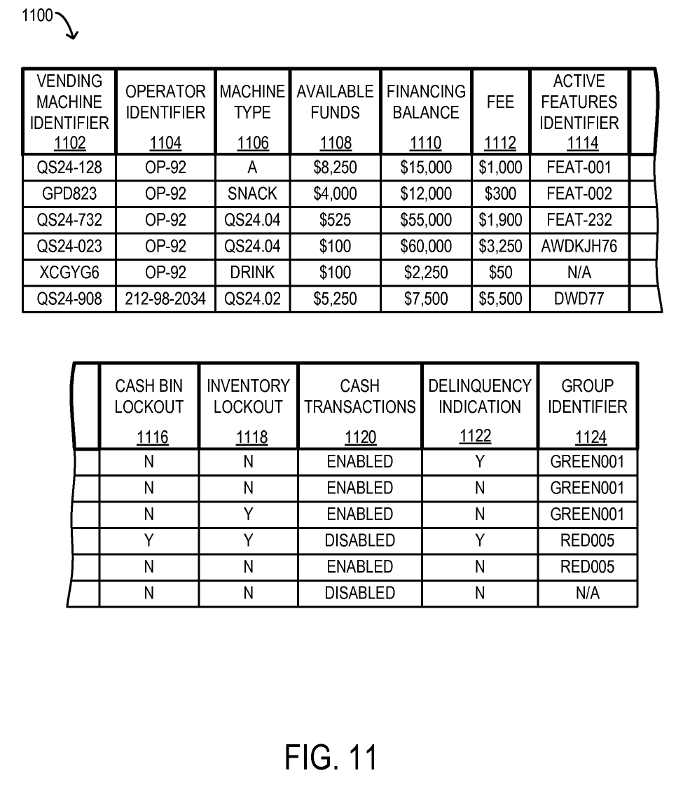

Referring now to FIG. 11, a data table diagram illustrating an example data structure 1100 according to some embodiments is shown. The exemplary data structure 1100 may, in some embodiments, include a number of example records or entries, each of which may be associated with a vending machine. Each vending machine may be associated with one or more operators and/or with one or more vending agreements. The exemplary data structure 1100 may be utilized, for example, to determine vending machine data (e.g., available funds, number of units of a product stocked), deactivate and/or re-activate vending machine features, etc. The exemplary data structure 1100 may also generally comprise fewer or more entries, as is or becomes desirable or practicable.

The exemplary data structure 1100 may generally define fields for each of the entries or records. The fields may include, for example: (i) a vending machine identifier field 1102 (e.g., that uniquely identifies a vending machine); (ii) an operator identifier field 1104 (e.g., that uniquely identifies an operator associated with the vending machine); (iii) a machine type field 1106 (e.g., that indicates a type, model, and/or class of the vending machine); (iv) an available funds field 1108 (e.g., that indicates an amount of funds stored in and/or otherwise available or attributable to the vending machine); (v) a financing balance field 1110 (e.g., that indicates an amount of debt associated with the vending machine); (vi) a fee field 1112 (e.g., that indicates a fee associated with the vending machine); (vii) an active features identifier field 1114 (e.g., that indicates one or more features of the vending machine that are activated); (viii) a cash bin lockout field 1116 (e.g., that indicates whether the operator of the vending machine is currently prevented from accessing funds available to the vending machine); (ix) an inventory lockout field 1118 (e.g., that indicates whether the operator of the vending machine is currently prevented from accessing the inventory of the vending machine); (x) a cash transactions field 1120 (e.g., that indicates whether cash transactions are currently allowed at the vending machine); (xi) a delinquency indication field 1122 (e.g., that indicates whether the operator and/or the vending machine is associated with a delinquent payment—such as a payment pursuant to a vending agreement); and/or (xii) a group identifier field 1124 (e.g., that indicates a group associated with the vending machine).

The exemplary data structure 1100 may be accessed by various devices and/or for various purposes. For example, a processor of a vending machine (e.g., the vending machines 120, 220 of FIG. 1 and/or FIG. 2) and/or a controller (e.g., the controller 110, 210 of FIG. 1 and/or FIG. 2) may access the exemplary data structure 1100 to determine one or more settlement parameters associated with a vending machine. In some embodiments, the processor of the vending machine or a processor of a peripheral device or controller may access the exemplary data structure 1100 to (i) determine one or more vending machine associated with an operator and/or a vending agreement, (ii) determine funds available and/or attributable to a vending machine and/or group of vending machines, (iii) calculate a settlement amount, (iv) determine a vending machine corrective action status, and/or (v) determine vending machine features and/or activated features. According to some embodiments, alternative or additional fields (not shown) may include, for example, a vending machine serial number field, a vending machine firmware version field, a vending machine stock date field, a vending machine location field, a vending machine agreement identifier, etc.

### VI. Apparatus

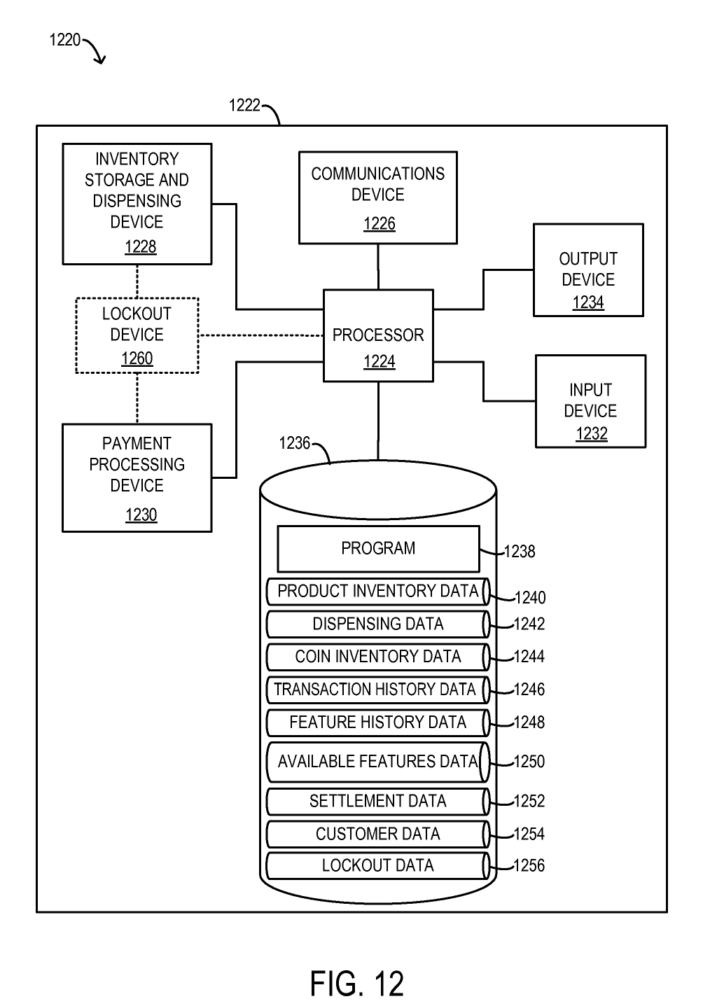

Turning now to FIG. 12, a block diagram of a system 1220 according to some embodiments is shown. In some embodiments, the system 1220 may be utilized, for example, to carry out any of the methods 300, 400, 500, 600 described with respect to any of FIG. 3, FIG. 4, FIG. 5, and/or FIG. 6 herein. In some embodiments, the system 1220 may be similar in configuration and/or functionality to any of the vending machines 120, 220 of FIG. 1 and/or FIG. 2 described herein. The system 1220 may comprise, for example, a casing 1222 enclosing one or more of a processor 1224, a communications device 1226, an inventory and dispensing device 1228, a payment processing device 1230, an input device 1232, an output device 1234, and/or a data storage device 1236. According to some embodiments, the system 1220 may be configured to perform and/or facilitate processes in accordance with embodiments described herein. The system 1220 may, for example, be utilized in accordance with one or more vending agreements, be associated with one or more financing agreements or arrangements, be operable to change functionality (e.g., to facilitate settlement), and/or be capable of vending network cooperative financing and/or settlement.

A. Casing/Cabinetry

In some embodiments, a suitable casing 1222 and/or cabinetry may be constructed from any known or practicable material, including but not limited to any combination of (i) commercial grade sixteen-gauge steel (e.g., for exterior panels and internal shelving), (ii) transparent materials such as glass or Plexiglas (e.g., for product display windows), (iii) rubber (e.g., for waterproofing insulation), (iv) plastic, and/or (v) aluminum.

Many commercially available casings 1222 may be adapted to work in accordance with various embodiments. For example, in snack machine embodiments, a suitable casing 1222 may comprise the “129 SnackShop” manufactured by Automatic Products International, Ltd. of Saint Paul, Minn., which stands at seventy-two inches (72″/1829 mm) wide, has a width of thirty-eight and seven eighths inches (38⅞″/988 mm), and a depth of thirty-five inches (35″/1889 mm). Other suitable snack machine casings 1222 include the A La Carte® machine from Automatic Products, and the GPL SnackVendor® model #159 from Crane Merchandising Systems/Crane Co. of Stamford, Conn.

In beverage machine embodiments, casings 1222 commercially available from Dixie Narco, Inc. of Williston, S.C. may be employed. Beverage machine casings 1222 may comprise a “cooler” or “glass front” style front panel, featuring a transparent front panel (e.g., glass) allowing customers to see inventory for sale. Alternatively, beverage machine casings 1222 may comprise a “bubble front” style front panel, featuring a decorative front panel, typically used to advertise a logo of a product manufacturer commercially interested in the operation of the system 1220. In some embodiments, the front panel of the casing may be utilized as an output device to display indications of operator non-compliance and/or delinquency, as described herein.

Other embodiments are contemplated as well, including combination snack and beverage vending machine embodiments, such as those available from Crain Co. Further details concerning the suitability of general machine casings 1222 and/or standard and/or available cabinetry are well known in the art, and need not be described in further detail herein.

B. Processor/Controller

According to some embodiments, the system 1220 may include the processor 1224 that may be or include any type, quantity, and/or configuration of processor that is or becomes known. The processor 1224 may comprise, for example, an Intel® IXP 2800 network processor or an Intel® XEON™ Processor coupled with an Intel® E7501 chipset. In some embodiments, the processor 1224 may comprise multiple inter-connected processors, microprocessors, and/or micro-engines. According to some embodiments, the processor 1224 may include or be coupled to one or more clocks or timers (not explicitly shown) and to the communication device 1226 through which the processor 1224 may communicate, in accordance with some embodiments, with other devices such as one or more peripheral devices, one or more servers, and/or one or more user devices (such as the customer devices 204 and/or the controller 110, 210 of FIG. 1 and/or FIG. 2). The communication device 1226 may, for example, comprise any type or configuration of communication port, cable, modem, and/or signal transceiver that is or becomes known or practicable.

In some embodiments, the processor 1224 may also or alternatively be in communication with and/or coupled to any number of other components of the system 1220 such as the inventory and dispensing mechanism 1228, the payment processing mechanism 1230, the input device 1232, the output device 1234, and/or the data storage device 1236.

C. Inventory Storage and Dispensing Device

In some embodiments, the system 1220 may comprise the inventory storage and dispensing device 1228. The inventory storage and dispensing device 1228 may, according to some embodiments, comprise any number and/or configuration of devices and/or components that facilitate and/or are associated with the storage and/or dispensing of products or services available via the system 1220. Product inventory storage and product dispensing functions of the system 1220 configured in accordance with a snack machine embodiment may include, for example, one or more of: (i) a drive motor, (ii) metal shelves, (iii) a product delivery system (e.g., a chute, product tray, and/or product tray door), (iv) dual spiral (e.g., double helix) item dispensing rods, (v) convertible (e.g., extendable) shelves, and/or (vi) a refrigeration unit. In embodiments using the casing 1222 of the “model 129 SnackShop” manufactured by Automatic Products, three (3) removable shelves may be employed, together providing for thirty (30) product rows and an inventory capacity of between one hundred and eighty-five (185) to five hundred and twenty-two (522) commonly vended snack products.

Inventory storage and distribution functions of the system 1220 configured in accordance with a beverage machine embodiment may include one or more conventional components, including: (i) metal and/or plastic shelving, (ii) product dispensing actuators/motors, (iii) product delivery chutes, and/or (iv) a refrigeration unit.

In many types of beverage and snack vending machines, operators will typically stock several units of the same product linearly arranged in a column, allowing individual units to be dispensed upon command. The same product may be stocked in more than one column. Similarly, more than one product may be stocked in a single column. In the case that one or more services are available via the system 1220, the inventory storage and dispensing device 1228 may comprise any device or component that is associated with the storage, transmission, encoding or decoding (e.g., including encryption and decryption), and/or other processing, routing, or electronic delivery or redemption of such services.

Further details concerning typical vending machine inventory storage and dispensing devices 1228 are well known in the art, and need not be described in further detail herein.

D. Payment Processing Device

According to some embodiments, the system 1220 may comprise the payment processing device 1230. The payment processing device 1230 may, according to some embodiments, comprise any number and/or configuration of devices and/or components for receiving payment and/or dispensing change, including a coin acceptor, a bill validator, a card reader (e.g., a magnetic stripe reader), and/or a change dispenser.

In some embodiments, a magnetic stripe card reader may read data on a magnetic stripe of a credit or debit card, for example, and it may cooperate with conventional POS credit card processing equipment to validate card-based purchases through a conventional transaction authorization network. Suitable card-based transaction processing systems and methods are available from USA Technologies. Inc.™ of Wayne, Pa. In some embodiments, a coin acceptor, bill validator and/or change dispenser may communicate with and/or be coupled to a currency storage apparatus (a “hopper”; not shown) and may comprise conventional devices such as models AE-2400, MC5000, TRC200 by Mars. Inc.™ of West Chester, Pa., or CoinCo™ model 9300-L.

Coin acceptors and/or bill validators may receive and validate currency that is stored by the currency storage apparatus. Further, a bill validator or coin acceptor may be capable of monitoring stored currency and maintaining a running total of the stored currency, as is discussed with reference to U.S. Pat. No. 4,587,984, entitled “Coin Tube Monitor Means”, the payment and coin-related aspects of which are incorporated by reference herein. According to some embodiments, a change dispenser activates the return of coinage to the customer where appropriate (e.g., where a customer rejects or otherwise fails to accept a promotional offer). Such apparatus may feature Multidrop Bus (MDB) and/or Micromech peripheral capabilities, as are known in the art.

In another embodiment, the system 1220 may be configured to receive payment authorization and/or product selection commands or signals through a wireless device communication network (e.g., via the communication device 1226), directly or indirectly, from a customer device (e.g., a cellular telephone, not shown; the customer device 204 of FIG. 2). In such an embodiment, the payment processing device 1230 may comprise a cellular transceiver operatively connected to the processor 1224 to receive, transmit, and/or process such signals. Systems and methods allowing for the selection of and payment for vending machine products via cellular telephones are provided by USA Technologies. Inc.™. Further, in such an embodiment, a customer cellular telephone may serve as an input device 1232 and/or an output device 1234, as described elsewhere herein.

Further details concerning typical vending machine payment processing devices 1230 are well known in the art, and need not be described in further detail herein.

E. Input and Output Devices

According to some embodiments, the system 1220 may comprise the input device 1232 and/or the output device 1234. In some embodiments, the input device 1232 may be operable to receive input from (i) a customer indicating a product and/or offer selection, from (ii) an operator (or agent thereof) during stocking or maintenance of the system 1220, and/or from (iii) a controlling entity (e.g., to affect functionality of the system 1220). Also, the output device may be configured for outputting product and/or offer information (such as subscription and/or package deal information and/or other promotional messages or indications of delinquency) to a customer, operator, and/or third party.

Many combinations of input devices 1232 and output devices 1234 may be employed according to various embodiments. In some embodiments, the system 1220 may include more than one input device 1232. For example, the system 1220 may include an exterior input device 1232 for receiving customer input and an interior input device 1232 (neither shown separately) for receiving operator input. In some embodiments, the input device 1232 may provide the dual functionality of receiving input data from both operators and customers (and/or third parties). Likewise, the system 1220 may comprise more than one output device 1234 (e.g., an LCD screen and several LED devices, as described herein). In some embodiments, such as those which feature touch screens (described elsewhere herein), the functionality of both input devices 1232 and output devices 1234 may be provided by a single device.

Many input devices 1232 are contemplated. Thus, an input device 1232 may comprise one or more of the following: (i) a set of alpha-numeric keys for providing input to the vending machine, such as the Programmable Master Menu® Keypad, (ii) a selector dial, (iii) a set of buttons associated with a respective set of item dispensers, (iv) a motion sensor, (v) a barcode reader (e.g., a 1-D or 2-D barcode reader), (vi) a voice recognition module, (vii) a Dual-Tone Multi-Frequency receiver/decoder, (viii) a wireless device (e.g., a cellular receiver; a radio-frequency receiver; an infrared receiver; a wireless access point or wireless router; other wireless devices), (ix) a smart card reader, (x) a magnetic stripe reader. (xi) a biometric identification apparatus (e.g., an iris scanner, a retinal scanner, a facial recognition device, a thumbprint reader, etc.), (xii) a customer device, and/or (xiii) any other type or configuration of input device 1232 that may be or become known or practicable.

In some embodiments, an input device 1232 may comprise an optical reader (e.g., a 2-D bar code scanner) capable of scanning a barcode, such as a bar code which is displayed on a screen or monitor of a user's cellular phone, PDA, Blackberry® business phone, Blackberry® handheld or other handheld device. One system employing such technology, the Cmode® service, has been developed by a partnership between Coca-Cola® Co. and NTT DoCoMo™ Inc. of Japan. According to some embodiments, the input device 222 may comprise a fingerprint (e.g., and/or thumbprint) reader such as a Fujitsu® MBF200 Scanner, which is manufactured by Tacoma Technology. Inc of Taipai, Taiwan and Fujitsu® Microelectronics America. Inc. of Tokyo, Japan. The Fujitsu® MBF200 offers a resolution of five hundred dots per inch (500 dpi), an image capture area of 12.8×15 mm (0.5″×0.6″), and a unit size of 60×40×15 mm (2.4″×1.6″×0.6″). The Fujitsu® MBF200 may communicate with a vending machine processor 1224 through any practicable interface such as a USB interface. The Fujitsu® MBF200 may be desirable in an embodiment where the vending machine processor 1224 is instructed through a Linux-based operating system. In embodiments featuring the Fujitsu® MBF200, fingerprint-matching software may be employed. Exemplary fingerprint matching software may include, for example, VeriFinger™ 4.2 from Neurotechnologija, Ltd. of Vilnius, Lithuania.

In some embodiments, a suitable fingerprint reader for use as an input device 1232 may include the AF-S2 FingerLoc™ from AuthenTec®. Inc. of Melbourne, Fla. The AF-S2 FingerLoc™ offers a resolution of two hundred and fifty dots per inch (250 dpi), an image capture area of 13×13 mm (0.51″×0.51″), and a unit size of 24×24×3.5 mm (0.94″×0.94″×0.14″). The AF-S2 FingerLoc™ may communicate with a vending machine processor through any practicable interface such as a USS interface. The AF-S2 FingerLoc™ may be desirable in an embodiment where the vending machine processor 1224 is instructed through a Microsoft® Windows®-based operating system. In embodiments featuring the AF-S2 FingerLoc™, fingerprint matching software may be employed. Exemplary fingerprint matching software may include, for example, VeriFinger™ 4.2 from Neurotechnologija, Ltd. of Vilnius, Lithuania.

Likewise, many types of output devices 1234 are contemplated. For example, an output device 1234 may comprise an LCD screen or device. Alternatively or additionally, the output device 1234 may comprise one or more LED displays or devices (e.g., several alphanumeric multi-color or single color LED displays on the shelves of a vending machine associated proximately with each row of product inventory).

In one embodiment, an LED display screen is mounted atop and/or on the vending machine (via bolts or other mounting hardware) and is used to communicate offers and other messages (e.g., product advertisements, such as package deals and/or subscription offers or promotions) to prospective customers. A suitable LED display screen for such an embodiment may be housed in an aluminum case having a length of approximately twenty-seven and one half inches (27.5″/698.5 mm), a height of approximately four and one quarter inches (4.25″/107.95 mm), and a depth of approximately one and three quarter inches (1.75″/44.5 mm). Such a display screen may have a display area capable of showing about thirteen (13) alphanumeric and/or graphical characters. Further, such an LED display screen may comprise a serial computer interface, such as an RJ45/RS232 connector, for communicating with the processor 1224. Further still, such an LED display may be capable of outputting text and graphics in several colors (e.g., red, yellow, green, black) regarding current and upcoming promotions.

Further, in some embodiments, the output device 1234 may comprise a printer. In one embodiment, a printer may be configured to print on card stock paper of approximately one hundredth of an inch or less (e.g., 0.01″/0.15 mm or less) in thickness, such as the EPSON EU-T400 Series Kiosk Printer. Further, a printer may be capable of thermal line printing of various alphanumeric and graphical symbols in various font sizes (e.g., ranging from nine (9) to twenty-four (24) point) on various types of paper. Additionally, such a printer may communicate with the processor 114 via an RS232/IEEE 12834 and/or bidirectional parallel connection. Such a printer may further comprise a data buffer of various practicable sizes, such as approximately four kilobytes (4 KB). In some embodiments, the printer may be operable to output codes and/or identifiers (e.g., by printing vouchers) to customers and/or to print stickers, labels, and/or other indications to be attached to products vended by the system 1220. The output device 1234 may also comprise a device operable to attach and/or print indications of access codes onto one or more products of the system 1220 (e.g., as the products are loaded by an operator, while the products are shelved within the system 1220, and/or as the products are dispensed—such as a hopper printing and/or coupling mechanism). According to some embodiments, the output device 1234 may also or alternatively comprise an audio module, such as an audio speaker, that outputs information to customers audibly.

As stated, in some embodiments, a touch-sensitive screen may be employed to perform both input device 1232 and output device 1234 functions. Suitable, commercially available touch screens for use according to various embodiments are manufactured by Elo TouchSystems. Inc., of Fremont, Calif., such as Elo's AccuTouch series touch screens. Such touch screens may comprise. (i) a first (e.g., outer-most) hard-surface screen layer coated with an anti-glare finish, (ii) a second screen layer coated with a transparent-conductive coating, and/or (iii) a third screen layer comprising a glass substrate with a uniform-conductive coating. Further, such touch screens may be configured to detect input within a determined positional accuracy, such as a standard deviation of error less than plus or minus eight hundredths of an inch (0.08″/2 mm). The sensitivity resolution of such touch screens may be more than one hundred thousand touchpoints per square inch (100,000 touchpoints/in²/15,500 touchpoints/cm²) for a thirteen inch (13″) touch screen. For such touch screens, the touch activation force required to trigger an input signal to the processor 1224 via the touch screen may typically be around two to four ounces (2-4 ounces/57-113 g). Additionally, touch screens for use according to various embodiments may be resistant to environmental stressors such as water, humidity, chemicals, electrostatic energy, and the like. These and other operational details of touch screens (e.g., drive current, signal current, capacitance, open circuit resistance, and closed circuit resistance) are well known in the art and need not be described further herein.

In some embodiments, input and/or output functionality of the system 1220 may be facilitated through a wireless device configured to send data to, and/or receive data from, a customer device (e.g., the customer device 204 of FIG. 2), such as a laptop computer or a cellular telephone. In some embodiments, such a wireless device may comprise a sensor that detects signals from a customer device. Such signals may include but are not limited to radio frequency signals and/or IR signals. Thus, in one or more embodiments, a wireless input device 1232 may comprise a WAP or router configured to operate in accordance with an IEEE 802.11 standard, including the 802.11b and 802.11g standards, which transmit at 2.4 GHz, or the 802.11a standard, which transmits at 5 GHz. Such a wireless input device 1232 may, in some embodiments, have the capability to “frequency hop” between radio frequencies so as to reduce interference and/or increase security. Encryption techniques may also or alternatively be employed to increase the security of transmissions. Suitable WAPs are available from Belkin™ Corporation of Compton, Calif. and Cisco™ Systems. Inc. of San Jose, Calif. The wireless input device 1232 may, in some embodiments, be used to establish a communication link (such as a first communication link with a customer device) as described herein.

Additionally, in some embodiments, an output device 1234 may comprise an audio module, such as an audio speaker, that outputs information to customers audibly. Speakers may comprise conventional speakers and/or modem hypersonic speakers. An output device 1234 may include, for example, unidirectional and/or hypersonic speakers which can selectively focus sound to particular locations or customers, while not disturbing others who are not in the location of the focused sound.

For a description of such speakers, see Maney, Kevin, “Sound Technology Turns the Way You Hear on its Ear”, USA Today®, published May 20, 2003, and available at http://www.usatoday.com/tech/news/techinnovations/2003-05-19-hss_x.htm, the unidirectional and/or hypersonic speaker concepts and descriptions of which are hereby incorporated by reference herein.

In some embodiments, the output device 1234 may comprise a physical device having a game theme, such as a spinning “prize wheel” similar to those featured on the television game show Wheel of Fortune™ or The Price is Right™, a roulette wheel, mechanical slot machine reels, or the like. Such a wheel may communicate to customers various information. For example, the wheel may spin and stop on an icon that represents, e.g., a prize entitlement. A physical wheel in the general appearance of the wheel on the Wheel of Fortune™ game show may be attached to a vending machine.

Also or in addition to a wheel, another output device 1234 that is a peripheral device attached to and in communication with the system 1220 may communicate game-related information. By utilizing such an output device 1234, the system 1220 may be retrofitted with a separate device to employ game-themed promotions. The use of removable peripheral devices may be important in certain situations (e.g., where doorways to interior locations are low), as such satellite devices may be removed during transport and attached once vending machines are brought to the intended location. Likewise, such peripheral devices may be side-mounted, where the ceiling height may impair other location of the peripheral. Further, the use of a separate device is advantageous in that it may be in communication with more than one systems 1220, allowing many systems 1220 to participate in game-themed vending promotions.

F. Data Storage/Memory

The data storage device 1236 may include any appropriate combination of magnetic, optical and/or semiconductor memory, and may include, for example, additional processors, communication ports, RAM, Read-Only Memory (ROM), a compact disc and/or a hard disk. The processor 1224 and the storage device 1236 may each be, for example: (i) located entirely within a single computer or other computing device; or (ii) connected to each other by a remote communication medium, such as a serial port cable, a Local Area Network (LAN), a telephone line, RF transceiver, a fiber optic connection and/or the like. In some embodiments for example, the system 1220 may comprise one or more computers (or processors 1224) that are connected to a remote server computer (e.g., via the communication device 1226) operative to maintain databases, where the data storage device 1236 is comprised of the combination of the remote server computer and the associated databases.

The data storage device 1236 may generally store one or more programs 1238 for controlling the processor 1224. The processor 1224 may perform instructions of the program 1238, for example, and thereby operate in accordance with some embodiments, and particularly in accordance with the methods described in detail herein. According to some embodiments, the program 1238 may comprise any number or type of programs that are or becomes known or practicable. In some embodiments, the program 1238 may be developed using an object oriented programming language that allows the modeling of complex systems with modular objects to create abstractions that are representative of real world, physical objects and their interrelationships. However, it would be understood by one of ordinary skill in the art that the embodiments described herein can be implemented in many different ways using a wide range of programming techniques as well as general purpose hardware systems or dedicated controllers.

The program 1238 may be stored in a compressed, un-compiled and/or encrypted format. The program 1238 furthermore may include program elements that may be generally useful, such as an operating system, a database management system and/or device drivers for allowing the processor 1224 to interface with computer peripheral devices and/or the various components of the system 1220. Appropriate general purpose program elements are known to those skilled in the art, and need not be described in detail herein.

Further, the program 1238 may be operative to execute a number of invention-specific objects, modules and/or subroutines which may include (but are not limited to) one or more subroutines to determine whether a promotion should be output; one or more subroutines to determine a promotion type; one or more subroutines to populate a promotion type (such as a subscription offer or promotion), thereby constructing a promotion instance; one or more subroutines to select a constructed promotion instance from a plurality of hypothetical promotion instances; one or more subroutines to determine an expected value of a promotion being considered for output; one or more subroutines to determine how and/or when products should be dispensed from the system 1220; one or more subroutines to determine and/or provide codes redeemable for products; one or more subroutines to provide management access to customer accounts (e.g., to customers and/or third parties); one or more subroutines to provide and/or facilitate the sale and/or management of customer accounts; one or more subroutines to determine and/or transmit promotional messages (e.g., via e-mail) to customers; one or more subroutines to facilitate and/or effectuate settlement; and/or one or more subroutines to activate and/or deactivate features of the system 1220. Examples of some of these subroutines and their operation are detailed with respect to the processes described herein.

The program 1238 may also or alternatively direct the processor 1224 (e.g., in conjunction with one or more peripherals or other devices) to operate with “preprogrammed intelligence”, such as “Artificial Intelligence” (AI). Among possible intelligent abilities attributed to a system 1220 may be the ability to recognize people by voice or image, the ability to understand spoken language, the ability to understand written language, the ability to synthesize spoken language, the ability to compose text, the ability to compose motivational text (such as promotional messages advertising products available at the vending machine), the ability to recognize patterns in human purchasing behavior, the ability to sense external “foot traffic” (i.e., people passing by), and the ability to transmit messages to a targeted group of people on a network (e.g., e-mail transmitted messages to particular customers).

According to some embodiments, the instructions of the program 1238 may be read into a main memory (not explicitly shown) of the processor 1224 from another computer-readable medium (such as the data storage device 1236), like from a ROM to a RAM. Execution of sequences of the instructions in the program 1238 may cause the processor 1224 to perform the process steps described herein. In alternative embodiments, hard-wired circuitry or integrated circuits may be used in place of, or in combination with, software instructions for implementation of the processes described herein. Thus, some embodiments are not limited to any specific combination of hardware, firmware, and/or software.

In addition to the program 1238, the data storage device 1236 may also be operative to store one or more databases, files, and/or tables, containing information such as (i) product inventory data 1240, (ii) dispensing data 1242, (iii) coin inventory data 1244, (iv) transaction history data 1246, (v) feature history data 1248, (vi) available features data 1250, (vii) settlement data 1252, (viii) customer data 1254 (e.g., which may include account data such as one or more e-mail addresses associated with a customer), and/or (ix) lockout data 1256. Any number of other arrangements may be employed besides those suggested by the tables shown. For example, even though nine (9) separate data tables, stores, files, and/or databases are illustrated, embodiments may be practiced effectively using fewer or more functionally equivalent databases or similar structures. These databases and/or other databases (not shown) may also or alternatively store information associated specifically with vending agreements and/or information useful in the management thereof. Vending machine financing terms, dates, rules, metrics, and/or settlement data, metrics, and/or parameters may, for example, be stored to facilitate the providing and/or management of vending agreements associated with the system 1220.

Further, despite the depiction of the data as tables, an object-based model could be used to store and manipulate the data types and likewise, object methods or behaviors can be used to implement the processes described herein.

G. Lockout Device

In some embodiments, system 1220 may also or alternatively comprise a lockout device 1260. While some, many, or all features associated with the system 1220 may generally be configurable, alterable, activated, deactivated, and/or otherwise managed (e.g., remotely) utilizing other components of the system 1220, for example, according to some embodiments, some features may also or alternatively be activated, deactivated, modified, and/or otherwise managed via one or more dedicated and/or specific devices or modules associated with the system 1220, such as the lockout device 1260. In embodiments where corrective action features may involve preventing access by an operator to a cash bin, inventory storage area, and/or other portion of the system 1220, for example, the lockout device 1260 may comprise a device or module operable to facilitate and/or implement the prevention of such access. In some embodiments, the lockout device 1260 may be in communication with the processor 1224, such as to receive instructions, commands, and/or signals that cause the lockout device 1260 to facilitate and/or implement lockouts.

The lockout device 1260 may also or alternatively be in communication with one or more of the inventory storage and dispensing device 1228 (e.g., to prevent dispensing of certain items, to lockout the operator from the inventory storage area or a portion thereof), the payment processing device 1230 (e.g., to activate and/or disable cash or electronic transactions), and/or other practicable devices, as is or becomes desirable. The lockout device 1260 may be coupled to the input device 1232, for example, to alter the functionality of the input device 1232, such as by preventing certain types of input, by preventing selection of certain options, etc. In some embodiments, the lockout device 1260 may be operable and/or coupled to communicate directly with a remote device such as the controller 110, 210 of any of FIG. 1 and/or FIG. 2 herein. The lockout device 1260 may receive, via a network for example, a communication (e.g., a signal) from a controller, wherein the signal indicates an action or state associated with the lockout device 1260. In accordance with the signal, the lockout device 1260 may then, according to some embodiments, verify and/or change state or position, such that lockout requirements or requests from the controller may be implemented. In some embodiments, the lockout device 1260 may comprise a timer and/or may be in communication with a timer or clock. In such embodiments, the lockout device may be operable to lock or latch automatically upon the passage of a pre-determined amount of time, unless a “keep alive” code is provided by the operator, controller, etc.

The lockout device 1260 may generally comprise any type or configuration of lock, latch, relay, solenoid, switch, logic gate, software, and/or firmware operable to alter functionality of the system 1220 (and/or any component thereof that is or becomes known or practicable. In some embodiments, such as in the case that the lockout device 1260 is operable to prevent physical access to a component of the system 1220, the lockout device 1260 may comprise an electric lock and/or latch. The lockout device 1260 may also or alternatively comprise an electronic access device such as an electronic access receiver, RFID reader, etc., that is operable to grant or deny access to the system 1220 (e.g., by altering and/or managing which permissions and/or access codes are operable to disengage a lock and/or latch of the system 1220). In some embodiments, the lockout device 1260 may comprise a switch that is operable to prevent an electronic access device from receiving power (e.g., thereby preventing the electronic access device from being operable to provide access to a portion of the system 1220).

According to some embodiments, the lockout device 1260 may simply comprise a shield, partition, cover, and/or blocking device that is operable to physically impede access and/or functionality of the system 1220. Such a blocking device may comprise, for example, a cover that is engaged to (i) prevent coin and/or bills from being inserted into the payment processing device 1230, (ii) prevent certain keys and/or buttons from being pressed, (iii) prevent a keyhole from being accessed, (iv) prevent an input device 1232 and/or an output device 1234 (and/or portion thereof) from being accessed and/or viewed, etc. Such a device may comprise a plastic, metal, and/or composite object coupled to the system 1220 that is moved electronically, mechanically, magnetically, and/or via any combination thereof, to alter functionality of the system 1220 as is desired (such as in accordance with corrective action embodiments described herein).

H. Retrofitting

In some embodiments, one or more of the processor 1224, the input device 1232, the output device 1234, and the data storage device 1236 may be included, wholly or partially, in a separate device (e.g., separate from and/or external to the casing 1222; not shown), such as the e-Port™ by USA Technologies Inc., that may be in communication with the system 1220. The separate devices may also or alternatively be in communication with a network such as the Internet (e.g., via the communication device 1236).

The e-Port™ is a credit and smart card-accepting unit that controls access to office and MDB vending equipment, and serves as a point of purchase credit card transaction device. The e-Port™ includes an LCD that allows for the display of color graphics, and a touch sensitive input device (touch screen) that allows users to input data to the device. The display may be used to prompt users interactively with, e.g., offers and information about their transaction status.

The separate device may alternatively be a programmed computer running appropriate software for performing various functions described herein. The separate device may be operable to receive input from customers, receive input from third parties, receive payment from customers, exchange information with a remotely located server (e.g., an ISP server, a VoIP service provider's server) and/or display or transmit messages to customers (e.g., promotional messages and/or offers). The separate device may be operable to instruct the vending machine that appropriate payment has been received (e.g., via a credit card read by the separate device), that a particular product or products should be dispensed by the vending machine, and/or how and/or when those products should be dispensed (e.g., to avoid product collisions and/or other complications). Further, a separate device may be operable to instruct the vending machine to execute and/or offer customer accounts, promotional messages, price changes, or the like.

Thus, a separate device may be operatively connected to the system 1220 to perform various processes and steps described herein including the offering of a benefit in exchange for a customers e-mail address, as well as transmitting promotional messages to the customers e-mail address. In this manner, conventional vending machines may be retrofitted with such separate devices so as to perform the processes described herein.

I. Other Separate Devices

It should be noted that, in some embodiments, some or all of the functions and method steps described herein may be performed partially or entirely by one or more separate devices (not explicitly shown), which are not necessarily retrofitted to a system 1220, Separate devices for use with such an embodiment include, but are not limited to, kiosks and customer devices (PDA devices, laptop computers, and cellular telephones). In some embodiments featuring separate devices, such devices may be capable of communicating, directly (e.g., via Bluetooth® connectivity) or indirectly (e.g., through a web server or IVRU), to a vending machine control system in order to facilitate the inventive functionality described herein. In some embodiments featuring separate devices, such separate devices are capable of communicating with a remote computer.

J. Network Embodiments

Network environments may include a remotely located device or computer (e.g., a server, mainframe, or other device) that is in communication, via a communications network, with one or more systems 1220 (e.g., vending machines 120, 220 of FIG. 1 and/or FIG. 2) and/or customer devices (e.g., customer devices 204 of FIG. 2). Such a configuration may facilitate third party management of customer accounts and/or transmission of promotional e-mail messages as described herein.

The remote device or computer may communicate with the systems 1220, customer devices, and/or third party devices, and the systems 1220 may communicate with each other, directly or indirectly, via a wide variety of wired and/or wireless means, mediums, protocols and communications standards. Some, but not all, possible communication links and networks that may comprise the network or be otherwise part of the system include but are not limited to: PSTN links, satellite links, cellular links, optical links, infrared links, radio frequency links, and/or Cable TV links. Various networking configurations, standards and protocols may be employed, including but not limited to: IP addressing via the Internet, a local area network (LAN), a wireless LAN, a wide area network (WAN), Ethernet (or IEEE 802.3), Token Ring, SAP, ATP, Bluetooth™, TCPIIP and/or via any appropriate combination thereof. Communication may be encrypted to ensure privacy and prevent fraud in any of a variety of ways well known in the art.

Systems 1220 may comprise computers, such as those based on the Intel® Pentium® or Centrino™ processor, that are adapted to communicate with the remote device or computer. Any number and type of machines may be in communication with the remote device or computer.

Systems 1220, devices and/or computers in communication with each other need not be continually transmitting to each other. On the contrary, such vending machines, devices and/or computers need only transmit to each other as necessary, and may actually refrain from exchanging data most of the time. For example, a vending machine in communication with another machine via the Internet may not transmit data to the other machine for weeks at a time.

In some embodiments, the remote device or computer may be accessible, directly or indirectly, via a separate device (such as a customer device and/or third party device) by a customer, operator, and/or third party. Accordingly, a customer, operator, and/or third party may use a device to communicate with the remote computer. A separate device may receive from the remote computer messages described herein as being output by the system 1220 (e.g., subscription codes), and/or may transmit to the remote computer input described herein as being provided to the system 1220 (e.g., e-mail addresses). Thus, various data described herein as received through an input device of a system 1220 may be received by the system 1220 from a separate device (e.g., through a Bluetooth® connection) or from a remote computer (which may relay data first received from a customer device such as a personal computer). Similarly, various data described herein as received through an input device 1232 of a system 1220 may be received through a Web browser communicating with a remote server, which in turn communicates with the system 1220.

K. External Appearance

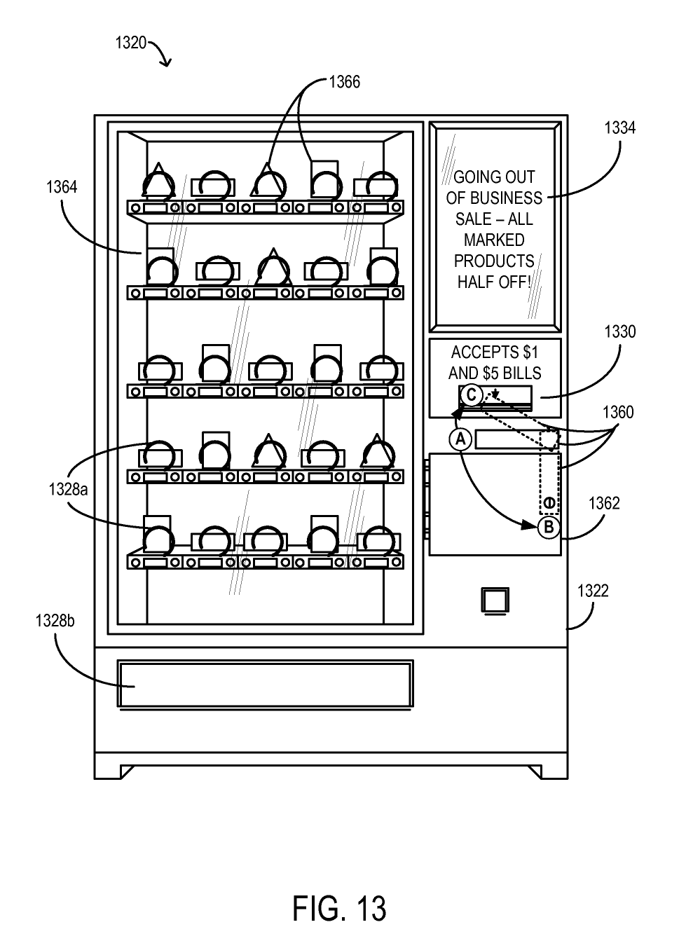

Referring to FIG. 13, a diagram illustrating an example of the external appearance of a vending machine 1320 according to some embodiments is shown. In some embodiments, the exemplary vending machine 1320 may be similar in configuration and/or functionality to the vending machines 120, 220 and/or the system 1220 described in conjunction with any of FIG. 1, FIG. 2, and/or FIG. 12. The exemplary vending machine 1320 may comprise, for example, (i) a cabinet 1322, (ii) an inventory dispensing mechanism 1328a-b (comprising a product storage mechanism 1328a and/or a product hopper 1328b). (iii) a payment processing mechanism 1330, (iii) an output device 1334 (e.g., for outputting promotional messages associated with available features of the vending machine 1320 and/or for outputting indications of operator delinquency or poor performance), (iv) a lockout device 1360, (v) a cash bin 1362, and/or (vi) a product display window 1364 behind which are visible the products 1366 available for sale from the vending machine 1320 and the product storage mechanism 1328a that holds the products 1366 within the vending machine 1320. According to some embodiments, the components 1322, 1328, 1330, 1334, 1360 of the vending machine 1320 may be similar in configuration and/or functionality to the similarly named and/or numbered components described in conjunction with any of FIG. 1, FIG. 2, and/or FIG. 12 herein.

The casing 1322 may, fore example, comprise any type or configuration of cabinetry or enclosure to at least partially house components of the vending machine 1320. As described elsewhere herein, for example, the casing 1322 may be constructed of steel, aluminum, plastic, rubber, other metals or composite materials, and/or any combinations thereof. In some embodiments, the casing 1322 may be configured for the sale of various products or services such as a typical and/or modified version of a typical snack, beverage, dessert, meal, non-edible object, media, and/or any other vending machine 1320. According to some embodiments, the inventory dispensing mechanism 1328a-b may comprise various component such as the product storage mechanism 1328a and/or the product hopper 1328b). The product storage mechanism 1328a may, for example, comprise a number of latches, levers, paddles, doors, spirals, and/or other product retention, detention, and/or dispensing mechanisms, as are known in the art.

According to some embodiments, a product selected and/or purchased by a customer may be released by the product storage mechanism 1328a so that it falls into the product hopper 1328b. The product hopper 1328b may, according to some embodiments, comprise one or more doors, holes, and/or other means via which a customer may retrieve a dispensed product. The product hopper 1328b may also or alternatively comprise one or more components to facilitate prevention of unauthorized product removal (e.g., from someone reaching up into the vending machine 1320 via the product hopper 1328b) and/or to facilitate the reduction of impact forces experienced by products dropping from the product storage mechanism 1328b above.

In some embodiments, the payment processing mechanism 1330 may comprise any practicable type of payment receiving, transmitting, and/or processing device that is or becomes known (such as those described elsewhere herein). The payment processing mechanism 1330 may, for example, comprise a currency validator and/or input slot, such as shown in FIG. 13. According to some embodiments, the output device 1334 may display various information associated with offers and/or promotions and/or product or service sales to a customer. The output device 1334 may also or alternatively provide messages associated with corrective actions implemented on and/or in the vending machine 1320 (e.g., pursuant to a vending agreement). As shown in FIG. 13, for example, the output device 1334 may comprise a display screen (and/or touch screen) that advertises a half price sale for marked products (e.g., products indicated as ‘marked’ by illumination of one or more. LED devices).

The particular offer shown in FIG. 13, for example, may be a “going out of business sale” implemented to clear inventory from the vending machine 1320 in response to an operators breach or delinquency associated with a vending agreement pertaining to the vending machine 1320. As described herein, in the case that an operator's delinquent (e.g., severely delinquent) in paying appropriate financing fees associated with the vending machine 1320, for example, the vending machine 1320 may be remotely configured to institute a sale to (i) increase revenues and/or profits (e.g., to pay the fee), (ii) give the operator an incentive to pay the fee (e.g., as opposed to losing profits or revenues due to the sale), and/or (iii) empty the vending machine 1320 of inventory (e.g., to prepare for relocation or change of ownership).

In some embodiments, the corrective action may also or alternatively involve activation of the lockout device 1360. Revenues and/or profits may be increased by implementing the sale, for example, and the lockout mechanism 1360 may be engaged (pivoted from a disengaged position “A” to a first engaged position “B”, as shown in FIG. 13) to prevent the operator from accessing the cash bin 1362 (and the funds stored therein). The lockout device 1360 may also or alternatively be engaged (pivoted from the disengaged position “A” to a second engaged position “C”, as shown in FIG. 13) to prevent cash transaction at the vending machine 1320, such that all customer transactions may be required to be conducted electronically (e.g., routed to and/or conducted by the controlling entity). In some embodiments, the lockout device 1360 may be operable to set or alter a security setting associated with the payment processing mechanism 1330 such that bill and/or coin payments may be effectively disabled. A security tolerance of the payment processing mechanism 1330 may be set to zero (0), for example, such that substantially all bills and/or coins are automatically rejected (e.g., none are accepted and/or are likely to be accepted).

L. Software Architecture

In some embodiments, a control system may execute instructions for managing the operation of a vending machine (such as the vending machines 120, 220, 1320 and/or the system 1220 of FIG. 1, FIG. 2, FIG. 12, and/or FIG. 13), and in particular in accordance with various embodiments described herein. Such vending machine functions include, but are not limited to: (1) product pricing (e.g., displaying prices via an LED and/or changing such prices where appropriate), (2) processing vending transactions by (i) receiving customer selections via an input device (such as product and/or offer selections), (ii) processing payment via a payment processing mechanism, (iii) actuating corresponding product dispensing mechanisms, (3) selecting promotional messages or promotion types and constructing promotion offer instances, (4) outputting promotional messages and/or offers to customers via output devices (including display of graphics/content, such as game-themed content, on LCD and LED displays), (5) recording transaction information (inventory levels, acceptance rates for promotions, etc.), (6) facilitating settlement activities, (7) activating and/or deactivating features of the vending machine in response to remotely-received instructions and/or signals, (8) implementing corrective actions, (9) receiving redemption codes, and/or (10) automatically recharging a funded account by utilizing a customer credit card.

In some embodiments, machine components (e.g., machine hardware, including mechanical hardware such as input devices, output devices, product dispensing devices, lockout devices, and/or payment processing devices including coin acceptors, bill validators, card readers, and/or change dispensers) may be controlled by the control system through a standard RS-232 serial interface. In such embodiments, embedded Application Programming Interface (API) devices or modules may be used to enable software to actuate and/or control vending machine components via RS-232 connectivity. Such vending machine components may be operatively connected to the control system directly or indirectly, in any manner that is practicable. Alternatively, machine components may communicate with the control system through a USB standard (e.g., USB ports may allow plug-and-play installation of machine components).

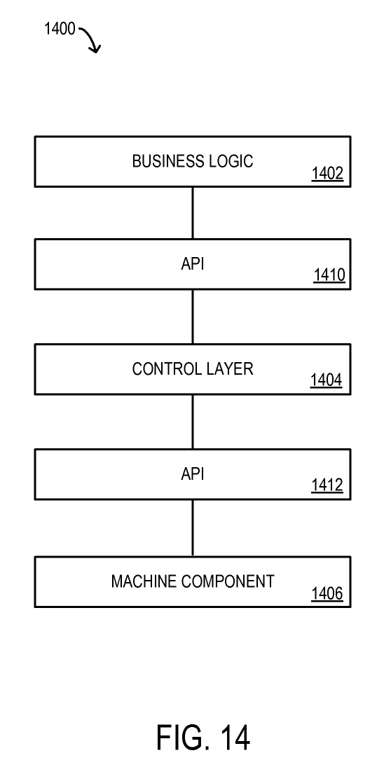

Referring now to FIG. 14, for example, a block diagram of a system 1400 according to some embodiments, is shown. The system 1400 may, for example, comprise and/or represent an exemplary portion of control software that may be utilized to implement some embodiments. The system 1400 illustrates, for example, control software as being divided into three (3) abstract components. Such division may provide a clear partition of tasks, which may be desirable so that any future modification and new programming can be applied without disrupting other components. The three (3) abstract components illustrated may generally include a Business Logic software component 1402, a Control Layer software component 1404, and an exemplary Machine Components software component 1406. Fewer or more machine components may be employed in some embodiments.

The software components are each generally connected to one another via a respective API 1410, 1412. As is known in the art, an API 1410, 1412 may comprise a set of routines, protocols, and/or tools for building software applications. The Business Logic software component 1402 may, according to some embodiments, be connected to the Control Layer software component 1404 via an API 1410. Similarly, the Control Layer software component 1404 may be connected to the Machine Component software component 1406 via another API 1412.

The Business Logic software component 1402 visually represents the portion of the software that selects promotions or promotion type instances and/or constructs promotion instances and/or promotional messages, and/or manages the features of the vending machine, as described herein. Such a component may, for example, access a payment history database and a vending machine database to perform various functions such as settlement and/or implementation of corrective actions.

The Control Layer software component 1404 visually represents the portion of the software which interfaces with at least one Machine Component software component 1406, and thereby transmits commands to perform such functions as: (i) outputting delinquency information via an output device (e.g. a machine component), (ii) dispensing products via a product dispensing mechanism (e.g., a machine component), (iii) dispensing change due to a customer via a payment processing mechanism, which may include a change dispenser and a currency storage apparatus (e.g., several machine components), (iv) deactivating the payment processing mechanism, (v) preventing access to a cash bin and/or inventory storage device or area, and/or (vi) otherwise facilitating and/or participating in settlement activities associated with one or more vending agreements.

The Machine Component software component 1406 generally represents software or machine hardware, including mechanical hardware such as input devices, output devices, lockout devices, inventory dispensing devices, and payment processing devices including coin acceptors, bill validators, card readers, change dispensers, etc.

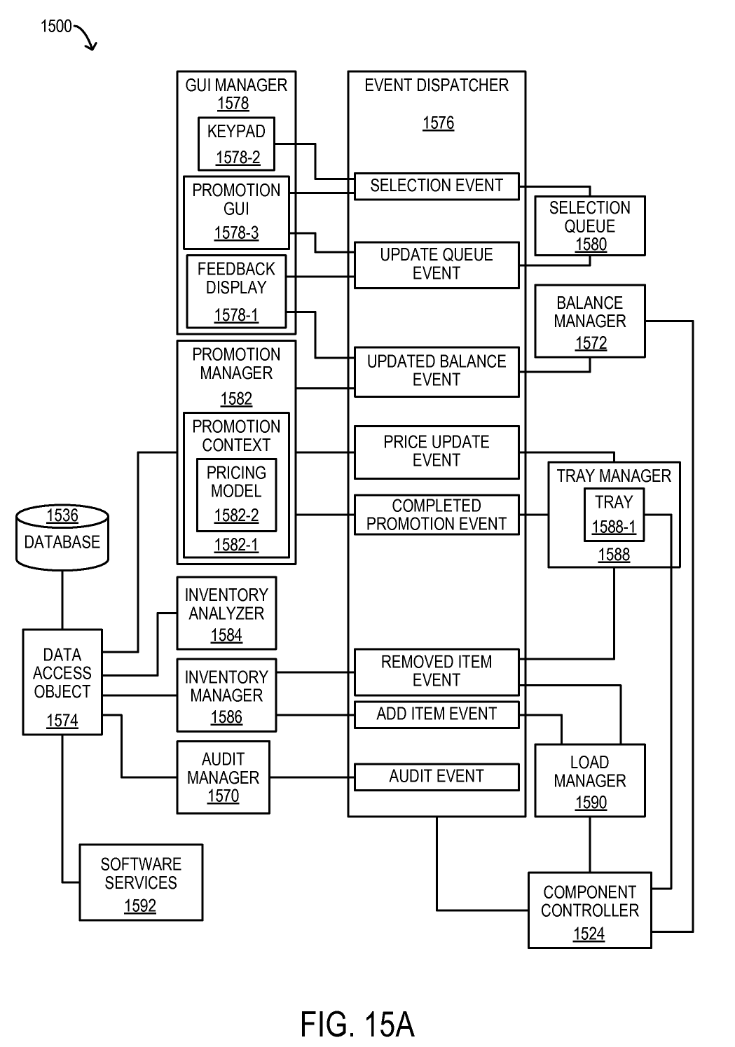

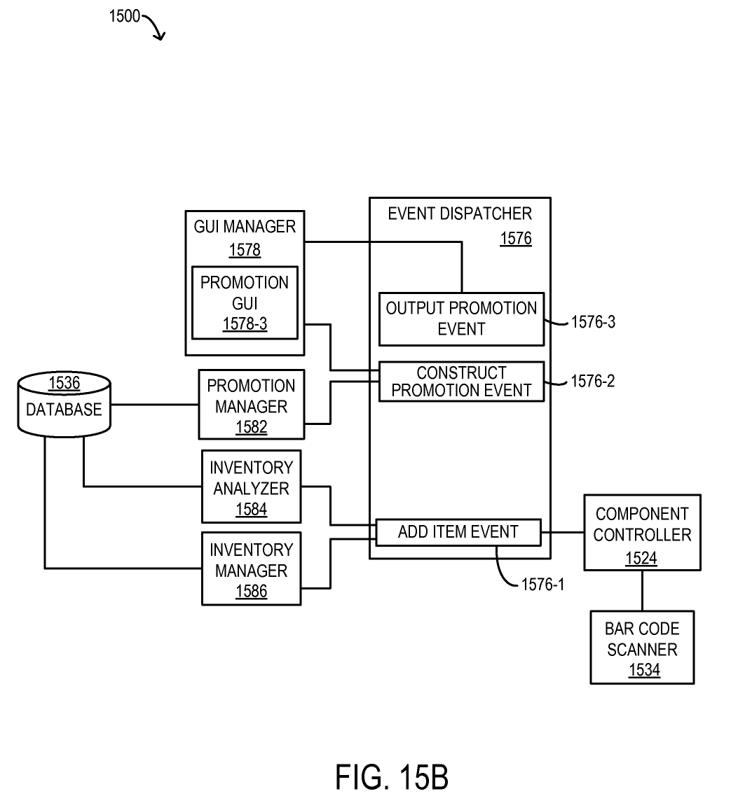

Referring now to FIG. 15A, a schematic block diagram of an exemplary configuration of a software architecture 1500 according to some embodiments is shown. It should be noted, however, that many architectural configurations are possible to carry out the inventive processes described herein. The software architecture 1500 is a model of a software application for use in execution of embodiments described herein, designed using Unified Modeling Language™ (UML™). The model p comprises various software components and illustrates how the various software components may interact with one another.

According to some embodiments, the software architecture 1500 may comprise a component controller 1524 and/or a database 1536. The component controller 1524 may manage (and mask the implementation of) vending machine components. Examples of vending machine components include: input devices, output devices, coin acceptors, bill validators, lockout devices, card readers, change dispensers, product dispensing mechanisms, and bar code readers. In some embodiments, the component controller 1524 may be similar in configuration and/or functionality to the processor 1224 described in conjunction with FIG. 12. The database 1536 may comprise a persistence store (e.g., MySQL, file based, and/or Oracle®). The database 1536 may, for example, be similar in configuration and/or functionality to the data storage device 1236 described in conjunction with FIG. 12.

In some embodiments, an audit manager 1570 listens for audit events fired by other management components and acts on them by persisting meaningful state about the event to audit data structures. This function journals all significant events, transactions, and other meaningful system operations so that they can be used in subsequent analysis and reporting functions. The definition of “meaningful state” can potentially be specified through configuration management. The event/configuration driven approach provides flexibility if auditing/reporting requirements change.

According to some embodiments, a balance manager 1572 represents the current monetary balance in the machine. It interacts with the component controller 1524 and responds to money insertion (and/or electronic funds provisions) by incrementing its balance value. It fires UpdatedBalance events whenever the balance changes. It listens for DrainBalance events and executes processes of the component controller 1524 that return funds to the user.

In some embodiments, a data access object 1574 may be the layer of abstraction that is responsible for persisting domain objects such as inventory objects and audit data. The data access object 1574 may, for example, be in communication with the database 1536 and/or one or more other data stores (not shown).

According to some embodiments, an event dispatcher 1576 acts as a proxy broker for events so that components do not need to explicitly listen to each other (e.g., have undue knowledge of each other by reference). Some examples of events that may be managed by this component, and that are shown in FIG. 15A, include: a SelectionEvent event, an UpdatedQueueEvent event, an UpdatedBalanceEvent event, a TrayLEDUpdateEvent event, a CompletedPromotionEvent event, a DispenseditemEvent event, an AuditEvent event, and/or an EnterOperatorModeEvent event.

In some embodiments, a Graphical User Interface (GUI) manager 1578 is a container for all GUI components and/or sub-components and defines their layout in reference to one another. The GUI manager 1578 will also listen for events from the event dispatcher 1576. Swing events may be handled by the individual sub-components 1578-1, 1578-2, 1578-3 of the GUI manager 1578. According to some embodiments, the sub-components may comprise a feedback display 1578-1, a keypad 1578-2, and/or a promotion GUI 1578-3. The feedback display 1578-1 is a sub-component that manages feedback from the keypad 1578-2, instructions, and error messages.

The keypad 1578-2 is a sub-component that represents the keypad data entry interface (rendered as Swing graphical objects on a touch screen LCD). It forces selection events to be fired that are relevant to the feedback display 1578-1 and a selection queue 1580.

The promotion GUI 1578-3 is a sub-component that represents promotion-related user interface rendering such as graphical selection menus, banners, animation, etc. The promotion GUI 1578-2 fires events that can affect the selection queue 1580 and listens for events from a promotion manager 1582. The selection queue 1580 is a container for cumulative product selections made during the course of user interaction with a promotional offer and/or promotion. The promotion manager 1582 manages the entire promotional offer and/or promotion-related business rules in play in a vending machine. It can manage multiple promotional offer and/or promotion contexts simultaneously and executes all rules related to validation, execution, and workflow related to offer or promotion contexts. This component implements a promotional offer or promotion context factory object that encapsulates business rule logic related to promotional offer and/or promotion eligibility, selection, pricing and composition.

In some embodiments, the promotion manager 1582 may comprise, define, and/or manage one or more components such as a promotion context 1582-1 and/or a pricing model 1582-2. The promotion context 1582-1 may comprise all of the state and workflow rules required by the promotion manager 1582 to execute a given promotional offer and/or promotion. The pricing model 1582-2 may, according to some embodiments, be a sub-component of the promotion context 1582-1. The pricing model 1582-2 may, for example, contain all the product pricing data needed to execute the promotional offer and/or promotion described by that context.

According to some embodiments, an inventory analyzer 1584 performs derivation and aggregation computations on inventory state and audit data. The results of these computations are persisted for use by other components (e.g., the promotion manager 1582). The computation functions may be initiated on demand or by a scheduler service when the system is dormant.

In some embodiments, an inventory manager 1586 maintains the current state of the machine's inventory. It listens for events that will ask it to update the inventory that was fired by components such as a tray manager 1588 and a load manager 1590. The tray manager 1588 is the container and manager of composite tray components. It is responsible for initiating and coordinating multiple-product dispense operations. According to some embodiments, the tray manager 1588 may be a module and/or device that operates and/or manages a tray 1588-1. The tray 1588-1 may, for example, be a sub-component of the tray manager 1588 and/or may represents a product dispensing apparatus and its composite rows/slots in the vending machine. Its responsibilities include dispensing products and displaying LED data through the component controller 1524.

According to some embodiments, a load manager 1590 manages the inventory load processes. It may interact with a bar code scanner via the component controller 1514, such as when an operator restocks the machine's inventory. The load manager 1590 may also or alternatively fire inventory change events. Examples of load processors and/or devices are described in commonly owned and co-pending U.S. patent application Ser. No. 10/951,296 entitled “METHODS AND APPARATUS FOR DEFINING AND UTILIZING PRODUCT LOCATION IN A VENDING MACHINE” and filed on Sep. 27, 2004, the load management concepts and descriptions of which are incorporated by reference herein.

In some embodiments, a software service 1592 may provide miscellaneous application services, including (but not limited to): account management, configuration management, connection pooling, diagnostic logging, and/or scheduling services.

Referring now to FIG. 15B, a schematic block diagram of another exemplary configuration of the software architecture 1500 according to some embodiments is shown. The configuration of the software architecture 1500 shown in FIG. 15B is a model of a software application for use in some embodiments, designed using UML™. The software architecture 1500 may comprise various software components and one or more hardware components. For example, the software architecture 1500 may comprise a component controller 1524, a barcode scanner 1532, a database 1536, an event dispatcher 1576, a GUI manager 1578, a promotion manager 1582, an inventory analyzer 1584, and/or an inventory manager 1586. According to some embodiments, the components 1524, 1532, 1536, 1576, 1578, 1582, 1584, 1586 of the software architecture 1500 may be similar to the similarly named and/or numbered components described in conjunction with any of FIG. 1 and/or FIG. 15A herein.

In some embodiments, the event dispatcher 1576 may include and/or define three (or more) exemplary events. The events may comprise, for example, an AddItem event 1576-1, a ConstructPromotion event 1576-2, and/or an OutputPromotion event 1576-3. According to some embodiments, some or all of the events 1576-1, 1576-2, 1576-3 may be triggered by an addition of a product to a vending machine.

As shown in FIG. 15B, the component controller 1524 may be in communication with a particular vending machine component such as the bar code scanner 1532. In some embodiments, the bar code scanner 1532 may be similar in configuration and/or functionality to the input device 1232 described in conjunction with FIG. 12. The bar code scanner 1532 may, for example, be a particular type of input device 1232 (i.e., one that is operable to scan barcodes). In some embodiments, the component controller 1524 may be in communication with fewer or more components (such as input devices 1232 and/or output devices 1234) than are shown in FIG. 15B.

In some embodiments, when an operator of the vending machine adds a product to the inventory of the vending machine, the operator may scan a bar code of the product (e.g., using the bar code scanner 1532). The component controller 1524 communicates the input of the bar code scanner 1532 to the event dispatcher 1576, which recognizes the input of the bar code scanner 1532 as an AddItem event 1576-1. As described above, the event dispatcher 1576 may act as a proxy broker for events, alleviating the need for components to listen for events from other components. Thus, the event dispatcher 1576 may communicate the AddItem event 1576-1 to the inventory manager 1586, without the need for inventory manager 1582 to listen for events from the component controller 1524. The inventory manager 1582, in turn, may cause a record of the added item and/or of the AddItem event 1576-1 to be stored in the database 1536 (e.g., via the data access object 1574 from FIG. 15A, which is not illustrated in FIG. 15B for purposes of simplicity).

The inventory analyzer 1584, in turn, may analyze the current inventory (e.g., based on the addition of the product or based on another event, such as the occurrence of a predetermined time) and store an indication of a need for a promotional offer and/or promotion for two (2) or more products based on the current state of the inventory. The indication may be stored in database 1526. The promotion manager 1582 may, according to some embodiments, access the database 1536 and determine the need for a promotional offer and/or promotion. The promotion manager 1582 may then, for example, construct a promotional offer and/or promotion, based on the need. The event dispatcher 1576 may determine the occurrence of the ConstructPromotion event 1576-2 and communicate the occurrence of this event to the GUI manager 1578. The GUI manager 1578 may, in turn, cause the promotional offer to be displayed via a promotion GUI 1578-1 sub-component. The promotion GUI sub-component 1578-1 and/or the GUI manager 1578 may then, for example, construct the OutputPromotion event 1576-3. The event dispatcher 576 may, according to some embodiments, detect the OutputPromotion event 1576-3 and communicate the occurrence of this event to another component (e.g., promotion manager 1582) and thus, indirectly, cause a record of the output of the promotional offer to be stored in the database 1536.

M. Controller

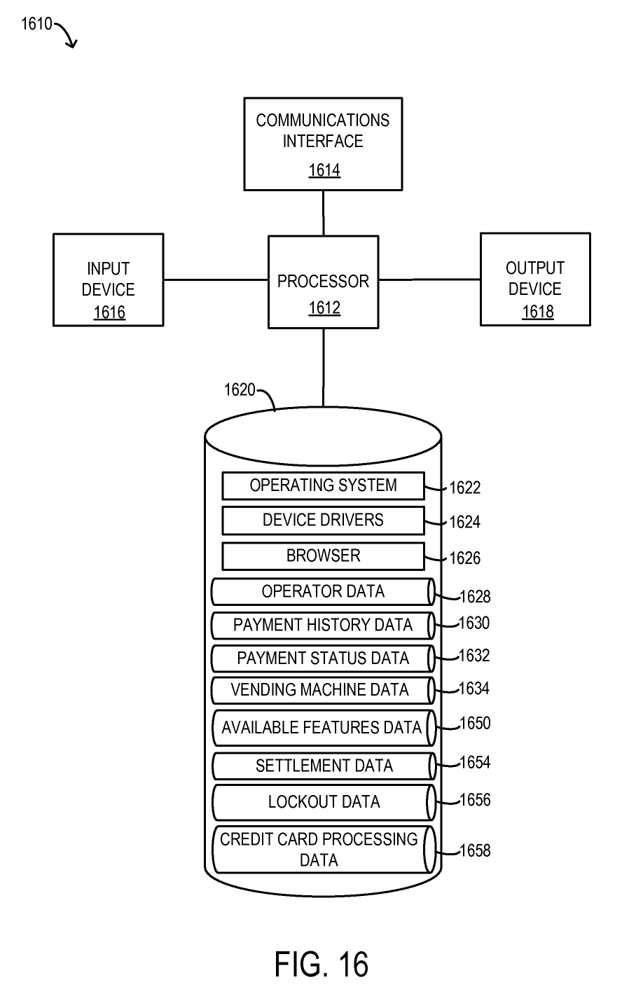

In some embodiments, a controller and/or other network device may be utilized to facilitate and/or implement various processes, methods, and/or procedures described herein. Referring to FIG. 16, for example, a block diagram of a system 1610 according to some embodiments is shown. In some embodiments, the system 1610 may be utilized, for example, to carry out any of the methods 300, 400, 500, 600 described with respect to any of FIG. 3, FIG. 4, FIG. 5, and/or FIG. 6 herein. The system 1610 may also or alternatively be associated with any of the systems 100, 200, 1220 described herein. According to some embodiments, different types, layouts, quantities, and configurations of systems may be used.

In some embodiments, the system 1610 may be or include a computer such as a computer server. According to some embodiments, the system 1610 may be a controller such as the controllers 110, 210 of FIG. 1 and/or FIG. 2 described herein. In some embodiments, the system 1610 may be a computer server and/or workstation utilized to facilitate, manage, and/or implement vending agreements (such as by conducting settlement operations and/or by performing other processes described herein). The system 1610 may generally include one or more processors 1612, which may be any type or configuration of processor, microprocessor, and/or micro-engine that is or becomes known or available. In some embodiments, the system 1610 may also or alternatively include one or more communication interfaces 1614, an input device 1616, an output device 1618, and/or a memory device 1620, all and/or any of which may be in communication with the processor 1612.

The communication interface 1614 may be or include any type and/or configuration of communication device that is or becomes known or available. In some embodiments, the communication device 1614 may allow the system 1610 (and/or the processor 1612) to communicate with, for example, a vending machine, a consumer, and/or one or more third parties. The input device 1616 and the output device 1618 may be or include one or more conventional devices such as displays, printers, keyboards, a mouse, a trackball, etc. The devices 1616, 1618 may be utilized, for example, by an server operator and/or system user (such as may be associated with a controlling entity) to effectuate, schedule, manage, and/or otherwise facilitate settlement processes.

The memory device 1620 may be or include, according to some embodiments, one or more magnetic storage devices, such as hard disks, one or more optical storage devices, and/or solid stale storage. The memory device 1620 may store, for example, an operating system 1622, device drivers 1624 (e.g., to interface with the input device 1618 and/or the output device 1616), applications, programs, procedures, and/or modules (not all explicitly shown). In some embodiments, the memory device 1620 may include a browser 1626. The browser 1626 may, for example, be a web browser and/or other program utilized by a user to interface with systems operating in accordance with some embodiments. The browser 1626 may, for example, facilitate management and/or conduction of settlement processes and/or activities associated therewith.

According to some embodiments, the memory device 1620 may also or alternatively comprise (i) operator data 1628, (ii) payment history data 1630, (iii) payment status data 1632, (iv) vending machine data 1634, (v) available features data 1650, (vi) settlement data 1652, (vii) lockout data 1656, and/or (viii) credit card processing data 1658. In the case that the system 1610 is a controller, for example, any or all of the data 1628, 1630, 1632, 1634, 1650, 1652, 1656, 1658 may be utilized by the system 1610 to facilitate and/or conduct vending agreement settlement and/or procedures associated therewith. In some embodiments, the data 1628, 1630, 1632, 1634, 1650, 1652, 1656, 1658 may be similar in configuration and/or composition to the data and/or data storage structures 700, 800, 900, 1000, 1100 and/or database tables 1250, 1252, 1256 described herein. In some embodiments, the system 1610 may otherwise be utilized to conduct, facilitate, and/or perform various embodiments described herein.

In the case that the system 1610 comprises a controller such as the controllers 110, 210 of FIG. 1 and/or FIG. 2, for example, the system 1610 may utilize the payment history data 1630 to determine a settlement date and/or amount (such as may be stored or indicated in the settlement data 1652). The system 1610 may also or alternatively utilize the credit card processing data 1658 to process electronic transactions associated with a customer of a vending machine (such as a vending machine indicated by data stored in the vending machine data 1634) and/or utilize any or all of the vending machine data 1634, the lockout data 1656, and/or the available features data 1650 to implement a corrective action such as preventing an operators access to the vending machines cash bin or inventory, and/or deactivating the vending machine's cash/coin payment accepting mechanism.

### VII. Examples

Various examples of some embodiments are now provided to assist in illustration of certain aspects of the systems, methods, and articles of manufacture described herein. The examples are not intended to be entirely comprehensive, exclusive, or limiting in any fashion. In general, while the methods and apparatus of some embodiments have been described in particular terms herein, those skilled in the art will recognize, after reading the present disclosure, that embodiments may be practiced with modification and alteration without departing from the teachings disclosed herein.

### A. Example #1

A vending machine manufacturer offers to provide a vending machine operator with a modernized vending machine and associated payment processing services in exchange for, among other things, twenty-eight percent (28%) of the monthly gross revenue generated by the machine. The machines modern features include wireless (e.g., cellular) network connectivity so that it can send/receive information to/from a central controller operated by the manufacturer, such as the controller 110, 210 of FIG. 1 and/or FIG. 2 herein. The machine also includes both (i) traditional payment processing devices for processing cash transactions (e.g., a bill validator and a coin acceptor), and (ii) a credit/debit card processing apparatus (including a magnetic stripe card reader). In this example, the vending machine manufacturer provides credit/debit card processing services to the operator (e.g., when a credit/debit card is tendered at the machine, the manufacturers controller receives the credit/debit card account number, processes the payment on the operators behalf, and transmits any appropriate authorization messages to the vending machine to dispense products totaling in price equal or less than the authorized amounts).

After accepting the vending machine manufacture's offer for the new machine, the operator places the modernized vending machine in the field at a busy college campus location. After three (3) months, the manufacturer's controller reports to the manufacturer that the operator has not paid any revenue whatsoever to the manufacturer, as is required pursuant to the agreement. Accordingly, the manufacturer authorizes the controller to send a command through the communication network to the vending machine, the command instructing the vending machine to accept no further cash payments (through the bill validator and coin acceptor) and only accept credit or debit card transactions.

Thereafter, when a student at the college attempts to tender a one-dollar ($1) bill to the vending machine's bill validator, the bill validator rejects the bill by reversing its motors and flashing an adjacent LED. Also, an LCD screen facing the student is caused to read, “Sorry, credit or debit card payments only”. The student then tenders a debit card by swiping his debit card through the machine's magnetic stripe card reader. The student's debit card number is communicated to the controller, which processes the payment and transmits an authorization message to the vending machine. The vending machine in turn permits the dispensing of products selected by the student.

Because the central controller processes all payments (now that cash payments at the machine are disabled), it is able to track and/or garnish all funds processed due to sales at the vending machine, thereby bolstering the manufacturers ability to collect its twenty-eight percent (28%) fee.

### B. Example #2

A vending machine operator finances a modernized vending machine through a vending machine manufacturer by agreeing to pay two hundred dollars per month ($200/month) for three (3) years. The financing agreement also provides that the manufacturer will provide credit and debit card processing services for the operator (e.g., as described in Example #1).

At the end of the first month, upon the operators making a monthly payment to the manufacturer through the manufacturers website, the manufacturer permits the operator to download a printable voucher containing a bar code. The voucher also contains instructions for the operator to deposit the voucher into the machine's bill validator within three (3) days in order to keep the bill validator active (or else it will shut off). The operator deposits the voucher, as instructed, within the three (3) day period, and the vending machine continues to accept paper currency for the next month.

At the end of the second month, the manufacturer's controller determines that the operator has not made his monthly payment. After a three (3) day grace period passes, the vending machine determines that it has not received an authorization bar code/voucher, and accordingly disables its bill validator and coin accepting apparatus. Because the vending machine still accepts credit and debit card payments (which are processed by the manufacturer), the manufacturer can track and/or garnish all funds processed due to sales at the vending machine, thereby bolstering the manufacturers ability to collect its two hundred-dollar ($200) monthly fee. If sales surpass four hundred dollars ($400) during the ensuing month (to account for the two hundred dollars ($200) missed payment and the current month's two hundred-dollar ($200) payment), the controller may permit the downloading of a bar coded voucher that would restore cash processing functionality to the machine. It should be understood that, instead of or in addition to the printed voucher, one or more electronic signals may be provided that engage and/or disable the vending machine's bill validator and/or coin accepting apparatus.

### C. Example #3

A vending machine operator purchases a vending machine priced at ten thousand dollars ($10,000) from a vending machine manufacturer. The operator purchases the vending machine by charging the ten thousand dollars ($10,000) to his credit card. The machine may communicate with the manufacturers central controller through a communications network, enabling the vending machine manufacturer to process consumer credit and debit card transactions on the operator's behalf (e.g., as in Example #1 and/or Example #2). As consumer credit and debit card charges are processed, the manufacturer periodically authorizes proportional “charge backs” against the operator's credit card until the ten thousand dollars ($10,000) charge is paid off.

Thus, by serving as a credit and debit card processor for consumer transactions at the vending machine, the manufacturer is able to help the operator service the credit card debt he incurred by purchasing the machine.

### D. Example #4

A vending machine operator and a manufacturer enter an agreement whereby the manufacturer will provide the operator with a modernized machine in exchange for, among other things, a monthly payment based on a percentage of sales. Before transferring possession of the vending machine to the operator, the manufacturer installs various promotions programs (coupon programs, sweepstakes game programs, etc.) in the vending machine's memory. At least one of the promotions programs is configured to require a code in order to operate. The operator and the manufacturer further agree that if sales at the machine reach or exceed one thousand dollars per month ($1,000/month), the manufacturer (or the manufacturer's controller) will distribute a code to the operator, allowing the operator to enter the code into the touch screen of the vending machine and thereby enable a new, previously inaccessible preinstalled promotion.

Encouraged by the prospect of a new promotions tool, the operator makes an extra effort to keep the machine clean, restocked and working properly during the first month of operations. When the manufacturers controller determines that one thousand dollars ($1,000) in sales has been reached before month's end, the manufacturer's controller e-mails the operator a code. The operator receives the code and enters the code into the vending machine's touch screen. Upon confirming the code, the vending machine enables a new sweepstakes game promotion.

Both parties benefited through the increased sales generated from the operators diligent attention to the machine during the month, and both parties hope to additionally benefit through the sweepstakes promotion in future months.

### E. Example #5

A vending machine operator and a manufacturer enter an agreement whereby the manufacturer will provide the operator with a modernized machine in exchange for, among other things, a monthly payment based on a percentage of sales. The operator and the manufacturer further agree that if sales at the machine reach one thousand dollars per month ($1,000/month), the manufacturers controller will permit, through a communications network, the downloading of one or more promotions programs to the vending machine.

Encouraged by the prospect of a new promotions tool, the operator makes an extra effort to keep the machine clean, restocked and working properly during the first month of operations. When the manufacturers controller determines that one thousand dollars ($1,000) in sales has been reached before the end of the month, the controller transmits a coupon program to the vending machine, which automatically installs and begins utilizing the new coupon program.

Both parties benefited through the increased sales generated from the operator's diligent attention to the machine during the month, and both parties hope to additionally benefit through the coupon promotion in future months.

### VIII. Additional Incorporated Materials

Fixed combination promotions are described at length in Applicant's U.S. patent application Ser. No. 09/012,163, filed on Jan. 22, 1998, and which issued as U.S. Pat. No. 6,397,193 on May 28, 2003 as “METHOD AND APPARATUS FOR AUTOMATICALLY VENDING A COMBINATION OF PRODUCTS”, as well as Applicant's co-pending U.S. patent application Ser. No. 10/095,372, filed on Mar. 11, 2002, and published as U.S. Publication No. 2002/0161653 on Oct. 31, 2002, entitled “METHOD AND APPARATUS FOR VENDING A COMBINATION OF PRODUCTS”, the combination promotion concepts and descriptions of each being incorporated by reference herein for all purposes.

Subscription promotions are described at length in Applicants U.S. patent application Ser. No. 09/545,596, filed on Apr. 7, 2000, and issued as U.S. Pat. No. 6,298,972 on Oct. 9, 2001, entitled “METHOD AND APPARATUS FOR ESTABLISHING AND MANAGING VENDING MACHINE SUBSCRIPTIONS”, U.S. patent application Ser. No. 09/353,269, filed on Jul. 14, 1999, and issued as U.S. Pat. No. 6,085,888 on Jul. 11, 2000, entitled “METHOD AND APPARATUS FOR ESTABLISHING AND MANAGING VENDING MACHINE SUBSCRIPTIONS”, and U.S. patent application Ser. No. 09/966,608, filed on Nov. 10, 1997, and issued as U.S. Pat. No. 5,988,346 on Nov. 23, 1999, entitled “METHOD AND APPARATUS FOR ESTABLISHING AND MANAGING VENDING MACHINE SUBSCRIPTIONS”, the subscription promotion concepts and descriptions of each being incorporated by reference herein for all purposes.

Various systems and methods for constructing, offering and processing dynamically priced upsell promotions are described in detail with reference to Applicant's U.S. patent application Ser. No. 09/012,163, filed on Jan. 22, 1998, and which issued as U.S. Pat. No. 6,397,193 on May 28, 2003 as “METHOD AND APPARATUS FOR AUTOMATICALLY VENDING A COMBINATION OF PRODUCTS”, as well as Applicant's co-pending U.S. patent application Ser. No. 10/095,372, filed on Mar. 11, 2002, and published as U.S. Publication No. 2002/0161653 on Oct. 31, 2002, entitled “METHOD AND APPARATUS FOR VENDING A COMBINATION OF PRODUCTS”, the upsell concepts and descriptions of each being incorporated by reference herein for all purposes.

Additional systems and methods for constructing, offering and processing dynamically priced upsell promotions are described in detail with reference to Applicant's U.S. patent application Ser. No. 08/920,116, filed on Aug. 26, 1997, which issued as U.S. Pat. No. 6,119,099 on Sep. 12, 2000, entitled “METHOD AND SYSTEM FOR PROCESSING SUPPLEMENTARY PRODUCT SALES AT A POINT-OF-SALE TERMINAL”, and Applicant's co-pending U.S. patent application Ser. No. 09/603,677, filed Jun. 26, 2000, entitled “METHOD AND APPARATUS FOR SELECTING A SUPPLEMENTAL PRODUCT TO OFFER FOR SALE DURING A TRANSACTION”, the upsell concepts and descriptions of each being incorporated by reference herein for all purposes.

Systems and methods for constructing, offering and processing alternate product promotions at vending machines are described in detail in Applicant's co-pending U.S. patent application Ser. No. 09/345,092, filed on Jun. 30, 1999, entitled “VENDING MACHINE SYSTEM AND METHOD FOR ENCOURAGING THE PURCHASE OF PROFITABLE ITEMS”, the alternate promotion concepts and descriptions of which are incorporated by reference herein for all purposes.

### IX. Rules of Interpretation

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments.

Neither the Title (set forth at the beginning of the first page of this patent application) nor the Abstract (set forth at the end of this patent application) is to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise,

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” means any one or more microprocessors, CPU devices, computing devices, microcontrollers, digital signal processors, or like devices.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CDROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth™, TUMA, ODMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
providing, in exchange for a fee, a vending machine to an operator, wherein the fee is scheduled to be paid by the operator on a periodic basis;
processing one or more electronic payment transactions associated with customers of the vending machine;
determining a history of payment of the fee by the operator;
determining, based at least in part on the history of payment of the fee by the operator, a settlement amount; and
settling with the operator for the settlement amount, wherein the settlement amount is based on an amount owed to the operator in association with the one or more processed electronic payment transactions associated with customers of the vending machine.

2. The method of claim 1, wherein the fee is based at least in part on sales data associated with the vending machine.

3. The method of claim 2, wherein the sales data comprises a number of units of product sold.

4. The method of claim 2, wherein the sales data comprises a profit margin of the vending machine.

5. The method of claim 2, wherein the sales data comprises a number of units of a specific product sold.

6. The method of claim 2, wherein the sales data comprises a number of vending machine subscription accounts registered.

7. The method of claim 2, wherein the sales data comprises a number of vending machine memberships sold.

8. The method of claim 1, further comprising:
determining whether the history of the payment of the fee by the operator meets a pre-determined historical payment criteria.

9. The method of claim 8, wherein, in the case that the history of the payment of the fee by the operator is determined not to meet the pre-determined historical payment criteria, the settlement amount is less than the amount owed to the operator in association with the one or more processed electronic payment transactions associated with customers of the vending machine.

10. The method of claim 8, wherein, in the case that the history of the payment of the fee by the operator is determined to meet the pre-determined historical payment criteria, the settlement amount is greater than or equal to the amount owed to the operator in association with the one or more processed electronic payment transactions associated with customers of the vending machine.

11. The method of claim 1, wherein the processing is conducted by a third-party on behalf of the operator.

12. The method of claim 11, wherein the processing and the providing are conducted by the third-party.

13. A method, comprising:
providing, in exchange for a fee, a vending machine to an operator, wherein the fee is scheduled to be paid by the operator on a periodic basis;
processing one or more electronic payment transactions associated with customers of the vending machine;
determining a history of payment of the fee by the operator;
determining, based at least in part on the history of payment of the fee by the operator, a settlement date; and
settling with the operator on the settlement date, wherein the settlement comprises reimbursing the operator any amount owed to the operator in association with the one or more processed electronic payment transactions associated with customers of the vending machine.

14. The method of claim 13, wherein the fee is based at least in part on sales data associated with the vending machine.

15. The method of claim 14, wherein the sales data comprises a number of units of product sold.

16. The method of claim 14, wherein the sales data comprises a profit margin of the vending machine.

17. The method of claim 14, wherein the sales data comprises a number of units of a specific product sold.

18. The method of claim 14, wherein the sales data comprises a number of vending machine subscription accounts registered.

19. The method of claim 14, wherein the sales data comprises a number of vending machine memberships sold.

20. The method of claim 13, further comprising:
determining whether the history of the payment of the fee by the operator meets a pre-determined historical payment criteria.

21. The method of claim 20, wherein, in the case that the history of the payment of the fee by the operator is determined not to meet the pre-determined-historical payment criteria, the settlement date is a first date and, in the case that the history of the payment of the fee by the operator is determined to meet the pre-determined historical payment criteria, the settlement date is a second date that is earlier than the first date.

22. A medium storing instructions adapted to be executed by a processor to perform a method, the method comprising:
provide, in exchange for a fee, a vending machine to an operator, wherein the fee is scheduled to be paid by the operator on a periodic basis;
process one or more electronic payment transactions associated with customers of the vending machine;
determine a history of payment of the fee by the operator;
determine, based at least in part on the history of payment of the fee by the operator, a settlement amount; and
settle with the operator for the settlement amount wherein the settlement amount is based on an amount owed to the operator in association with the one or more processed electronic payment transactions associated with customers of the vending machine.

23. An apparatus comprising:
a processor; and
a storage device that stores a program for directing the processor, the processor being operative with the program to:
provide, in exchange for a fee, a vending machine to an operator, wherein the fee is scheduled to be paid by the operator on a periodic basis;
process one or more electronic payment transactions associated with customers of the vending machine;
determine a history of payment of the fee by the operator;
determine, based at least in part on the history of payment of the fee by the operator, a settlement amount; and
settle with the operator for the settlement amount, wherein the settlement amount is based on an amount owed to the operator in association with the one or more processed electronic payment transactions associated with customers of the vending machine.

24. A medium storing instructions adapted to be executed by a processor to perform a method, the method comprising:
provide, in exchange for a fee, a vending machine to an operator, wherein the fee is scheduled to be paid by the operator on a periodic basis;
process one or more electronic payment transactions associated with customers of the vending machine;
determine a history of payment of the fee by the operator;
determine, based at least in part on the history of payment of the fee by the operator, a settlement date; and
settle with the operator on the settlement date, wherein the settlement comprises reimbursing the operator any amount owed to the operator in association with the one or more processed electronic payment transactions associated with customers of the vending machine.

25. An apparatus comprising:
a processor; and
a storage device that stores a program for directing the processor, the processor being operative with the program to:
provide, in exchange for a fee, a vending machine to an operator, wherein the fee is scheduled to be paid by the operator on a periodic basis;
process one or more electronic payment transactions associated with customers of the vending machine;
determine a history of payment of the fee by the operator
determine, based at least in part on the history of payment of the fee by the operator, a settlement date; and
settle with the operator on the settlement date, wherein the settlement comprises reimbursing the operator any amount owed to the operator in association with the one or more processed electronic payment transactions associated with customers of the vending machine.

26. A method, comprising:
providing, in exchange for a first fee, a first vending machine to an operator, wherein the first fee is a function of first sales data associated with the first vending machine;
providing, in exchange for a second fee, a second vending machine to the operator, wherein the second fee is a function of second sales data associated with the second vending machine;
determining, based on the function of the first sales data, that the first vending machine comprises insufficient funds to support payment of the first fee, a difference between the first fee and the funds of the first vending machine defining a deficiency amount;
determining, based on the function of the second sales data, that the second vending machine comprises funds in excess of the second fee, a difference between the second fee and the funds of the second vending machine defining an excess amount; and
collecting (i) the deficiency amount, (ii) the second fee, and (iii) at least a portion of the excess amount from the second vending machine, wherein the addition of the deficiency amount and the collected portion of the excess amount from the second vending machine is less than or equal to the first fee.

27. The method of claim 26, wherein the first vending machine comprises a first group of vending machines and the second vending machine comprises a second group of vending machines.

28. The method of claim 27, wherein the first and second groups are subgroups of a plurality of vending machines associated with the operator, the subgroups being defined, at least in part, based on a location associated with each of the plurality of vending machines.

29. The method of claim 27, wherein the first and second groups are subgroups of a plurality of vending machines associated with the operator, the subgroups being defined, at least in part, based on a vending machine type associated with each of the plurality of vending machines.

30. The method of claim 26, wherein at least one of the first and second sales-data comprises a number of units of product sold.

31. The method of claim 26, wherein at least one of the first and second sales data comprises a profit margin of at least one of the first and second vending machines.

32. The method of claim 26, wherein at least one of the first and second sales data comprises a number of units of a specific product sold.

33. The method of claim 26, wherein at least one of the first and second sales data comprises a number of vending machine subscription accounts registered.

34. The method of claim 26, wherein at least one of the first and second sales data comprises a number of vending machine memberships sold.

35. A medium storing instructions adapted to be executed by a processor to perform a method, the method comprising:
provide, in exchange for a first fee, a first vending machine to an operator, wherein the first fee is a function of first sales data associated with the first vending machine;
provide, in exchange for a second fee, a second vending machine to the operator, wherein the second fee is a function of second sales data associated with the second vending machine;
determine, based on: the function of the first sales data, that the first vending machine comprises insufficient funds to support payment of the first fee, a difference between the first fee and the funds of the first vending machine defining a deficiency amount;
determine, based on the function of the second sales data, that the second vending machine comprises funds in excess of the second fee, a difference between the second fee and the funds of the second vending machine defining an excess amount; and
collect (i) the deficiency amount (ii) the second fee, and (iii) at least a portion of the excess amount from the second vending machine, wherein the addition of the deficiency amount and the collected portion of the excess amount from the second vending machine is less than or equal to the first fee.

36. An apparatus comprising:
a processor; and
a storage device that stores a program for directing the processor, the processor being operative with the program to:
provide, in exchange for a first fee, a first vending machine to an operator, wherein the first fee is a function of first sales data associated with the first vending machine;
provide, in exchange for a second fee, a second vending machine to the operator, wherein the second fee is a function of second sales data associated with the second vending machine;
determine, based on the function of the first sales data, that the first vending machine comprises insufficient funds to support payment of the first fee, a difference between the first fee and the funds of the first vending machine defining a deficiency amount;
determine, based on the function of the second sales data, that the second vending machine comprises funds in excess of the second fee, a difference between the second fee and the funds of the second vending machine defining an excess amount; and
collect (i) the deficiency amount, (ii) the second fee, and (iii) at least a portion of the excess amount from the second vending machine, wherein the addition of the deficiency amount and the collected portion of the excess amount from the second vending machine is less than or equal to the first fee.

37. A method, comprising:
providing, in exchange for a fee, a vending machine to an operator, wherein the fee is scheduled to be paid by the operator on a payment date;
determining that the operators payment of the fee is delinquent; and
transmitting, after the determination that the operators payment of the fee is delinquent, one or more signals to prevent the operator from accessing a cash bin of the vending machine.

38. The method of claim 37, wherein the one or more signals are operative to cause a lock mechanism used by the operator to gain access to the cash bin to become inoperative.

39. The method of claim 37, wherein the one or more signals are operative to cause a key mechanism used by the operator to gain access to the cash bin to become inoperative.

40. The method of claim 37, wherein the vending machine comprises a first cash bin locking mechanism operable by the operator to gain access to the cash bin, and wherein the one or more signals are operative to cause a second cash bin lock mechanism not operable by the operator, to lock the cash bin.

41. The method of claim 37, wherein the one or more signals are operative to cause a security code associated with the vending machine cash bin to change.

42. A method, comprising:
providing, in exchange for a fee, a vending machine to an operator, wherein the fee is scheduled to be paid by the operator on a payment date;
determining that the operators payment of the fee is delinquent; and
transmitting, after the determination that the operators payment of the fee is delinquent, one or more signals to prevent the operator from accessing an inventory storage area of the vending machine.

43. The method of claim 42, wherein the one or more signals are operative to cause a lock mechanism used by the operator to gain access to the inventory storage area to become inoperative.

44. The method of claim 42, wherein the one or more signals are operative to cause a key mechanism used by the operator to gain access to the inventory storage area to become inoperative.

45. The method of claim 42, wherein the vending machine comprises a first inventory storage area locking mechanism operable by the operator to gain access to the inventory storage area, and wherein the one or more signals are operative to cause a second inventory storage area lock mechanism not operable by the operator, to lock the inventory storage area.

46. The method of claim 42, wherein the one or more signals are operative to cause a security code associated with the vending machine inventory storage area to change.

47. A medium storing instructions adapted to be executed by a processor to perform a method, the method comprising:
provide, in exchange for a fee, a vending machine to an operator, wherein the fee is scheduled to be paid by the operator on a payment date;
determine that the operators payment of the fee is delinquent; and
transmit after the determination that the operator's payment of the fee is delinquent, one or more signals to prevent the operator from accessing a cash bin of the vending machine.

48. An apparatus comprising:
a processor; and
a storage device that stores a program for directing the processor, the processor being operative with the program to:
provide, in exchange for a fee, a vending machine to an operator, wherein the fee is scheduled to be paid by the operator on a payment date;
determine that the operators payment of the fee is delinquent; and
transmit after the determination that the operator's payment of the fee is delinquent, one or more signals to prevent the operator from accessing a cash bin of the vending machine.

49. A medium storing instructions adapted to be executed by a processor to perform a method, the method comprising:
provide, in exchange for a fee, a vending machine to an operator, wherein the fee is scheduled to be paid by the operator on a payment date;
determine that the operator's payment of the fee is delinquent; and
transmit, after the determination that the operator's payment of the fee is delinquent, one or more signals to prevent the operator from accessing an inventory storage area of the vending machine.

50. An apparatus comprising:
a processor; and
a storage device that stores a program for directing the processor, the processor being operative with the program to:
provide, in exchange for a fee, a vending machine to an operator, wherein the fee is scheduled to be paid by the operator on a payment date;
determine that the operator's payment of the fee is delinquent; and
transmit, after the determination that the operator's payment of the fee is delinquent, one or more signals to prevent the operator from accessing an inventory storage area of the vending machine.

51. A method, comprising:
providing, in exchange for a fee, a vending machine to an operator, wherein the fee is scheduled to be paid by the operator on a payment date, and wherein the vending machine comprises a first payment processing device operable to process currency and a second payment processing device operable to process electronic payments;
determining that the operator's payment of the fee is delinquent and
transmitting, after the determination that the operator's payment of the fee is delinquent, one or more signals to disable the first payment processing device, such that any purchases at the vending machine must be made utilizing the second payment processing device.

52. The method of claim 51, further comprising:
withholding, from an amount owed to the operator in association with one or more processed electronic payment transactions associated with the second payment processing device, a delinquency amount.

53. The method of claim 52, further comprising:
determining, after the transmitting, that the delinquency amount is equivalent to the fee; and
transmitting, after the determination that the delinquency amount is equivalent to the fee, one or more signals to activate the first payment processing device.

54. The method of claim 52, further comprising:
determining that payment of the fee is provided by the operator after the payment date; and
determining a late fee associated with the delinquent payment of the fee.

55. The method of claim 54, further comprising:
determining, after the transmitting, that the delinquency amount is equivalent to the late fee; and
transmitting, after the determination that the delinquency amount is equivalent to the late fee, one or more signals to activate the first payment processing device.

56. A medium storing instructions adapted to be executed by a processor to perform a method, the method comprising:
provide, in exchange for a fee, a vending machine to an operator, wherein the fee is scheduled to be paid by the operator on a payment date, and wherein the vending machine comprises a first payment processing device operable to process currency and a second payment processing device operable to process electronic payments;
determine that the operators payment of the fee is delinquent; and
transmit, after the determination that the operator's payment of the fee is delinquent, one or more signals to disable the first payment processing device, such that any purchases at the vending machine must be made utilizing the second payment processing device

57. An apparatus comprising:
a processor; and
a storage device that stores a program for directing the processor, the processor being operative with the program to:
provide, in exchange for a fee, a vending machine to an operator, wherein the fee is scheduled to be paid by the operator on a payment date, and wherein the vending machine comprises a first payment processing device operable to process currency and a second payment processing device operable to process electronic payments;
determine that the operators payment of the fee is delinquent; and
transmit, after the determination that the operators payment of the fee is delinquent, one or more signals to disable the first payment processing device, such that any purchases at the vending machine must be made utilizing the second payment processing device.

58. A method, comprising:
providing, in exchange for a fee, a vending machine to an operator, wherein the fee is scheduled to be paid by the operator on a payment date,
determining that the operators payment of the fee is delinquent, and
transmitting, after the determination that the operators payment of the fee is delinquent, one or more signals to cause the vending machine to output an indication of the delinquency.

59. The method of claim 58, wherein the indication of the delinquency comprises a message to the operator, the message providing instructions associated with payment of the fee.

60. The method of claim 58, wherein the indication of the delinquency comprises a message to the operator, the message describing how late fees are calculated.

61. The method of claim 58, wherein the indication of the delinquency comprises an indication of late fees associated with the delinquency.

62. The method of claim 58, wherein the indication of the delinquency is displayed via a touch screen display of the vending machine.

63. The method of claim 58, wherein the indication of the delinquency is displayed via a cabinetry advertising area of the vending machine.

64. The method of claim 58, wherein the indication of the delinquency is output via a speaker of the vending machine.

65. The method of claim 58, wherein the indication of the delinquency comprises a message to customers of the vending machine.

66. The method of claim 58, wherein the indication of the delinquency comprises a change in color of at least a portion of the vending machine.

67. The method of claim 58, wherein the indication of the delinquency is output periodically.

68. The method of claim 58, wherein the indication of the delinquency is output substantially continually.

69. The method of claim 58, wherein the indication of the delinquency is output in the case that a customer is determined to be proximate to the vending machine.

70. The method of claim 58, further comprising:
determining, after the transmitting, that the operator has paid the fee; and
transmitting, after determining that the operator has paid the fee, one or more signals to cause the vending machine to cease outputting the indication of the delinquency.

71. A medium storing instructions adapted to be executed by a processor to perform a method, the method comprising:
provide, in exchange for a fee, a vending machine to an operator, wherein the fee is scheduled to be paid by the operator on a payment date;
determine that the operator's payment of the fee is delinquent, and
transmit, after the determination that the operators payment of the fee is delinquent, one or more signals to cause the vending machine to output an indication of the delinquency.

72. An apparatus comprising:
a processor; and
a storage device that stores a program for directing the processor, the processor being operative with the program to:
provide, in exchange for a fee, a vending machine to an operator, wherein the fee is scheduled to be paid by the operator on a payment date;
determine that the operators payment of the fee is delinquent; and
transmit, after the determination that the operator's payment of the fee is delinquent, one or more signals to cause the vending machine to output an indication of the delinquency.

73. A method, comprising:
providing, in exchange for a fee, a vending machine to an operator wherein the fee is scheduled to be paid by the operator on a payment date, and wherein the vending machine is operable to offer a feature to customers;
determining that the operator's payment of the fee is delinquent; and
transmitting, after the determination that the operators payment of the fee is delinquent, one or more signals to cause the vending machine to become inoperable to offer the feature to customers.

74. The method of claim 73, wherein the feature comprises a promotion.

75. The method of claim 74, wherein the promotion comprises a mystery promotion.

76. The method of claim 74, wherein the promotion comprises a vending machine subscription promotion.

77. The method of claim 74, wherein the promotion comprises a vending machine membership promotion.

78. The method of claim 74, wherein the promotion comprises an upsell promotion.

79. The method of claim 74, wherein the promotion comprises a package promotion.

80. The method of claim 73, wherein the feature comprises media content.

81. The method of claim 73, wherein the feature comprises the ability to pay cash for products offered for sale by the vending machine.

82. The method of claim 73, wherein the feature comprises the availability of one or more products offered for sale by the vending machine.

83. The method of claim 73, further comprising:
determining, after the transmitting, that the operator has paid the fee; and
transmitting, after determining that the operator has paid the fee, one or more signals to cause the vending machine to become operable to offer the feature to customers.

84. A medium storing instructions adapted to be executed by a processor to perform a method, the method comprising:
provide, in exchange for a fee, a vending machine to an operator, wherein the fee is scheduled to be paid by the operator on a payment date, and wherein the vending machine is operable to offer a feature to customers;
determine that the operators payment of the fee is delinquent; and
transmit, after the determination that the operators payment of the fee is delinquent, one or more signals to cause the vending machine to become inoperable to offer the feature to customers.

85. An apparatus comprising:
a processor; and
a storage device that stores a program for directing the processor, the processor being operative with the program to:
provide, in exchange for a fee, a vending machine to an operator, wherein the fee is scheduled to be paid by the operator on a payment date, and wherein the vending machine is operable to offer a feature to customers;
determine that the operators payment of the fee is delinquent; and
transmit, after the determination that the operator's payment of the fee is delinquent, one or more signals to cause the vending machine to become inoperable to offer the feature to customers.

86. A method, comprising:
providing, in exchange for a fee, a vending machine to an operator, wherein the fee is scheduled to be paid by the operator on a payment date, and wherein the vending machine is operable to dispense a plurality of products in accordance with one or more sales characteristics associated with each product of the plurality of products;
determining that the operator's payment of the fee is delinquent; and
transmitting, after the determination that the operator's payment of the fee is delinquent, one or more signals indicative of a change to the one or more sales characteristics associated with at least one of the products of the plurality of products.

87. The method of claim 86, wherein the sales characteristic comprises a product price.

88. The method of claim 86, wherein the sales characteristic comprises a product inventory group allocation.

89. A medium storing instructions adapted to be executed by a processor to perform a method, the method comprising:
provide, in exchange for a fee, a vending machine to an operator, wherein the fee is scheduled to be paid by the operator on a payment date, and wherein the vending machine is operable to dispense a plurality of products in accordance with one or more sales characteristics associated with each product of the plurality of products;
determine that the operator's payment of the fee is delinquent; and
transmit, after the determination that the operator's payment of the fee is delinquent, one or more signals indicative of a change to the one or more sales characteristics associated with at least one of the products of the plurality of products.

90. An apparatus comprising:
a processor; and
a storage device that stores a program for directing the processor, the processor being operative with the program to:
provide, in exchange for a fee, a vending machine to an operator, wherein the fee is scheduled to be paid by the operator on a payment date, and wherein the vending machine is operable to dispense a plurality of products in accordance with one or more sales characteristics associated with each product of the plurality of products;
determine that the operators payment of the fee is delinquent; and
transmit after the determination that the operators payment of the fee is delinquent, one or more signals indicative of a change to the one or more sales characteristics associated with at least one of the products of the plurality of products.

91. A method, comprising:
providing, in exchange for a fee, a vending machine to an operator, wherein the fee is scheduled to be paid by the operator on a periodic basis;
determining a history of payment of the fee by the operator;
determining, based at least in part on the history of payment of the fee by the operator, a promotion activation code; and
providing the promotion activation code to the operator, wherein the promotion activation code is operable to be accepted by the vending machine to activate one or more promotion capabilities of the vending machine.

92. The method of claim 91, wherein the promotion capability comprises a mystery promotion capability.

93. The method of claim 91, wherein the promotion capability comprises a vending machine subscription promotion capability.

94. The method of claim 91, wherein the promotion capability comprises a vending machine membership promotion capability.

95. The method of claim 91, wherein the promotion capability comprises an upsell promotion capability.

96. The method of claim 91, wherein the promotion capability comprises package promotion capability.

97. A medium storing instructions adapted to be executed by a processor to perform a method, the method comprising:
provide, in exchange for a fee, a vending machine to an operator, wherein the fee is scheduled to be paid by the operator on a periodic basis;
determine a history of payment of the fee by the operator;
determine, based at least in part on the history of payment of the fee by the operator, a promotion activation code; and
provide the promotion activation code to the operator, wherein the promotion activation code is operable to be accepted by the vending machine to activate one or more promotion capabilities of the vending machine.

98. An apparatus comprising:
a processor; and
a storage device that stores a program for directing the processor, the processor being operative with the program to:
provide, in exchange for a fee, a vending machine to an operator, wherein the fee is scheduled to be paid by the operator on a periodic basis;
determine a history of payment of the fee by the operator;
determine, based at least in part on the history of payment of the fee by the operator, a promotion activation code; and
provide the promotion activation code to the operator, wherein the promotion activation code is operable to be accepted by the vending machine to activate one or more promotion capabilities of the vending machine.
